(19) United States
(12) Patent Application Publication
(10) Pub. No.: US 2026/0212164 A1
(43) Pub. Date: Jul. 23, 2026

(54) SYSTEM AND METHOD FOR GENERATING FORMULATIONS USING MACHINE LEARNING ARCHITECTURES

(71) Applicant: THE GOVERNING COUNCIL OF THE UNIVERSITY OF TORONTO, Toronto (CA)

(72) Inventors: Julie AUDET, Toronto (CA); Ilham HAFIZOVIC, Oakville (CA); Alice Xue Ying FENG, Thornhill (CA)

(21) Appl. No.: 19/141,218

(22) PCT Filed: Dec. 18, 2023
(86) PCT No.: PCT/CA2023/051694

§ 371 Date: Jun. 19, 2025

Related U.S. Application Data
(60) Provisional application No. 63/433,802, filed on Dec. 20, 2022.

(51) Int. Cl. G06N 3/0475; G06N 3/045; G06N 3/0985

(52) U.S. Cl. CPC G06N 3/0475; G06N 3/045; G06N 3/0985

(57) ABSTRACT

There is provided systems and methods for generating formulations with improved performance and lower resource consumption. The population of formulations may be created by a Differential Evolution (DE) process. In each successive generation, lower performing formulations may be replaced with new formulations predicted to have better performance by a modeling pipeline. The modeling pipeline may perform a search for ML architectures and hyperparameter optimization for a suitable ML architecture, and then train one or more machine learning models to minimize error (otherwise maximizing the resulting score for a formulation). The machine learning models may be an ensemble of Random Forest models. These new formulations may form part of the next generation in the DE process. This modified version of the Differential Evolution process using machine learning techniques may result in populations of formulations which are superior in performance, and/or require fewer iterations of generations to achieve formulations which meet performance objectives.

### CROSS-REFERENCE TO RELATED APPLICATIONS

This claims the benefit of U.S. Provisional Patent Application No. 63/433,802, filed Dec. 20, 2022, the entire contents of which are incorporated herein by reference.

### FIELD

Embodiments of the present disclosure generally relate to the field of producing formulations, and in particular to systems and methods which utilize machine learning to enhance production of formulations.

### BACKGROUND

Formulations may be a combination of numerous ingredients or substances. Example formulations may include a mixture of molecules (e.g., peptides, proteins, amino acids, salts, polymers, RNA, among other examples), a mixture of metallic elements (alloys) configured to maximize physical properties, a combination of pharmaceuticals for maximizing solubility properties, a combination of genes for genetically engineering a microorganism strain, and/or a combination of building blocks that make up a macromolecule, among other examples. The generation or production of formulations may be a complex, resource-intensive process for which significant expenditures of time, materials, and resources may be required in order to produce formulations which possess desired properties. In some scenarios, different strategies, including design of experiments (DOE) operations may assist the development of formulations with improved properties and/or at lower resource cost.

### SUMMARY

Embodiments described in the present disclosure may include or incorporate Machine Learning (ML) systems, methods and architectures. In some embodiments, systems and methods may be configured for developing formulations having a large number of ingredients and/or constituents, and where the combination of the ingredients may exhibit non-linear or non-additive interactions or dose-response effects. In some scenarios, systems and methods may be configured for combining building blocks (e.g. for macromolecule design). The combination of such ingredients which will result in the production of a formulation with desired characteristics may be difficult to determine. In some scenarios, it may be resource intensive or costly to execute numerous experiments for one or more objectives, such as maximizing yield of a formulation product or to maximize yield of a formulation product while minimizing or reducing ingredient costs. It may be beneficial to provide systems and methods which make use of or otherwise incorporate machine learning techniques, which can reduce the number of experiments or iterations of experiments required to optimize a formulation or to obtain a formulation having desired characteristics or a desired level of performance.

Embodiments of systems and methods described in the present disclosure may be configured to develop or produce formulate preservatives, such as media for the preservation of biological material, including cryo-preservation. Such example formulations may be useful for maximizing lifetime or survival of biological material. Biological material may include, for example, cells (e.g. human T cells), tissues and organs, as well as plant matter (e.g. timber, rubber). Such formulations may also be used in foods or cosmetics. In some embodiments, embodiments described herein may identify and/or produce formulations of cell culture media. In some embodiments, a cell culture medium may be adapted to a particular cell type. In some embodiments, the particular cell type may be selected from a group consisting of: T cells, cardiac cells, animal cells, plant cells, algae cells, yeast cells, immune cells and/or mammalian cells.

In some scenarios, embodiments of systems and methods described herein may be configured for developing a microbial community (e.g. one or more micro-organism strains/species in different types and proportions). Such microbial communities may be adapted for bio-remediation and toxic waste treatment/degradation. In such examples, an example objective may be to maximize the rate of degradation of a certain type of compound. In other examples, an example objective for a microbial community may be to synthesize or maximize the rate of synthesis of a product.

In some scenarios, embodiments of systems and methods described herein may be configured for developing combination of genes for genetically engineering a microorganism strain such that it may better synthesize or degrade compounds. In this example, an example objective could be the yield of a compound of interest or its rate or titer of production.

In some scenarios, embodiments of systems and methods described herein may be configured for molecule design (e.g., peptides, polymers, RNA, among other examples) to maximize specific properties or biological activities. In such examples, factors may include different building blocks (e.g. amino acids, nucleic acids, saccharides) and the dose may be replaced by a different type of building block (e.g. 5 possible choices of factors to use as building blocks).

In some scenarios, embodiments of systems and methods described herein may be configured for formulating alloys to maximize physical properties (hardness, ductility, conductivity, among other example properties).

In some scenarios, embodiments of systems and methods described herein may be configured for formulating detergents, paints, dyes, adhesives, lubricants (automotive industry). In some scenarios, embodiments of systems and methods described herein may be configured for formulating combinations of chemotherapeutics to maximize activity or selectivity or pharmaceuticals for maximizing solubility of drugs (formulating co-solvents, surfactants). Many other uses of embodiments of systems and methods described herein are contemplated.

In one aspect, there is provided A machine learning modeling pipeline system for manufacturing a formulation using a differential evolution strategy, the system comprising: a processor; a memory coupled to the processor and storing processor-executable instructions that, when executed, configure the processor to: receive a respective score for each of a set of formulations, said formulations based on a plurality of factors and doses for said factors, said set of formulations including a top scoring subset of said formulations having scores which exceed a threshold, and said formulations further including a bottom scoring subset of said formulations having the lowest scores; store said respective scores in a memory module; generate, by a machine learning modeling pipeline, a plurality of predicted formulations predicted to have scores that exceed said scores of said bottom scoring subset, said predicted formulations having different factors and/or doses for said factors; determine a subsequent set of formulations for production, said subsequent set of formulations comprising said top scoring subset and replacing said bottom scoring subset with said plurality of predicted formulations.

In another aspect, there is provided a method of manufacturing a formulation using a differential evolution strategy and a machine learning modeling pipeline, the method comprising: receiving, by one or more processors, a respective score for each of a set of formulations, said formulations based on a plurality of factors and doses for said factors, said set of formulations including a top scoring subset of said formulations having scores which exceed a threshold, and said formulations including a bottom scoring subset of said formulations having the lowest scores; storing, by said one or more processors, said respective scores in a memory module; generating, by said machine learning modeling pipeline, a plurality of predicted formulations predicted to have scores that exceed said scores of said bottom scoring subset, said predicted formulations having different factors and/or doses for said factors; determining, by said one or more processors, a subsequent set of formulations for production, said subsequent set of formulations comprising said top scoring subset and replacing said bottom scoring subset with said plurality of predicted formulations. In another aspect, there is provided a non-transitory computer-readable medium or media having stored thereon computer-executable instructions that, when executed by one or more processors, cause the one or more processors to perform one or more operations as described herein.

In various further aspects, there is provided systems, devices, and logic structures such as machine-executable coded instruction sets and pseudocode for implementing various embodiments described herein.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will be apparent to those skilled in the art following a reading of the present disclosure.

### BRIEF DESCRIPTION OF THE FIGURES

In the figures, embodiments are illustrated by way of example. It is to be expressly understood that the description and figures are only for the purpose of illustration and as an aid to understanding example embodiments.

Embodiments will now be described, by way of example only, with reference to the attached figures, wherein:

FIG. 1 is a schematic diagram depicting operation of an example system incorporating a High-Dimensional Differential-Evolution with machine learning modelling (HiDiNeu) approach, in accordance with some embodiments of the present disclosure;

FIG. 2 depicts contour and response surface plots of factor interactions using experimental data collected on T-cell expansion guided by an HDDE approach, in accordance with some embodiments;

FIG. 3 is a depiction of error scores according to an L2 norm in formulations produced using a HiDiNeu system ANN-compared to traditional quadratic models;

FIG. 4 depicts plots of the Rosenbrock, Ackley and Rastrigin benchmark functions modified towards biologically relevant optimizations;

FIG. 5 illustrates HiDiNeu trained ANN models, in accordance with embodiments of the present disclosure;

FIG. 6 illustrates error scores relative to a solution of a Rosenbrock function;

FIG. 7 depicts error scores associated with top identified in silico Solution Vector (iSV) formulations produced using Differential Evolution, High-Dimensionality Differential Evolution, and HiDiNeu approaches according to different benchmarks and dimensionalities;

FIG. 8 illustrates normalized scores of top identified iSVs for the Ackley benchmark function using HDDE and HiDiNeu systems;

FIG. 9 depicts an example activation node within an artificial neural network (ANN), in accordance with some embodiments;

FIGS. 10 and 11 depict error scores for final top identified iSVs for DE, HDDE, and HiDiNeu systems with coefficients of variation of 30% and 70%, respectively;

FIGS. 12 and 13 illustrate normalized scores of top identified iSVs for HDDE and HiDiNeu systems for the Rastrigin and Rosenbrock benchmarks, respectively;

FIG. 14 illustrates standard benchmark functions Rosenbrock, Ackley, and Rastrigin modified towards biologically relevant optimization, and a visual depiction of the L2 norm error and normalized performance scores of certain identified top iSVs;

FIG. 15 illustrates normalized true scores of top identified iSVs for the Ackley benchmark from DE, HDDE and HiDiNeu approaches;

FIG. 16 illustrates normalized true scores of top identified iSVs for the Rosenbrock benchmark from DE, HDDE and HiDiNeu approaches;

FIG. 17 illustrates normalized true scores of top identified iSVs for the Rastrigin benchmark from DE, HDDE and HiDiNeu approaches;

FIG. 18 is a flow chart depicting an example process for an HiDiNeu system, in accordance with some embodiments;

FIG. 19 is a flow chart depicting an example process for selecting new top formulations to replace lower-performing formulations using machine learning techniques, in accordance with some embodiments;

FIG. 20 is a flow chart depicting an example process for a fully automated process for generating formulations having desired characteristics using an example HiDiNeu system, in accordance with some embodiments;

FIG. 21 is a block diagram depicting components of an example computing device 2100, in accordance with some embodiments;

FIG. 22 is a process diagram depicting an example in vitro implementation of a HiDiNeu system, in accordance with some embodiments;

FIG. 23 is a schematic diagram depicting operation of an example in vitro implementation of a HiDiNeu system, in accordance with some embodiments;

FIG. 24 is a schematic diagram depicting an overall process flow for an in vitro HiDiNeu system, in accordance with some embodiments;

FIG. 25 is a process diagram for an example in vitro implementation of a HiDiNeu system, in accordance with some embodiments;

FIG. 26 is a chart depicting dose levels of different factors in top identified iSVs from a previous HDDE study;

FIG. 27 is a chart depicting normalized scores (relative to HDDE) for top iSVs from generations 1-4 of an in vitro HiDiNeu production system, in accordance with some embodiments;

FIG. 28 is a lineage plot depicting the continuity between generations of formulations in an HiDiNeu system, in accordance with some embodiments;

FIG. 29 is a series of histograms depicting dose levels of certain factors across generations of top formulations for an in vitro HiDiNeu system, in accordance with some embodiments;

FIG. 30 is a series of histograms depicting dose levels of certain factors across generations of top formulations for an HDDE system;

FIG. 31 illustrates the relative normalized scores of different generations of top formulations produced using HDDE and an in vitro HiDiNeu system, in accordance with some embodiments;

FIG. 32 illustrates the results of a parametric one-way ANOVA for a randomized blocked design to illustrate the difference in mean cell expansion each of formulation IDs 119 to 128, where the groupings are various formulations tested in each of four generations;

FIG. 33 depicts the results of an ordered differences report depicting, for various pairs of formulations and controls tested side-by-side, statistically significant (top) versus non-significant (bottom) differences in mean performance scores, in accordance with some embodiments; and

FIG. 34 depicts a side-by-side comparison of top formulations produced using an in vitro HiDiNeu system relative to various controls including a control representing a top formulation produced using an HDDE system, in accordance with some embodiments.

### DETAILED DESCRIPTION

The description herein may utilize one or more abbreviations corresponding to the following concepts or expressions:
ANN Artificial Neural Network
AVP Actual-vs-Predicted Plot
BFGS Broyden-Fletcher-Goldfarb-Shanno algorithm
CAR Chimeric Antigen Receptor (e.g., CAR T cells)
CM Culture Media
CTP Cell-based Therapy Products
CV Coefficient of Variation
DE Differential Evolution
DOE Design of Experiments
Gi Generation i (where i∈ [symbol] ; e.g., 1,2,3, . . . , n)
HiDiNeu HDDE with machine learning modelling
HDDE High-Dimensional Differential-Evolution
iSVs in silico Solution-Vectors
MP Modelling Pipeline
NAS Neural Architecture Search
NPS Normalized Performance Scores
QbD Quality by Design
QTPP Quality Target Product Profiles
RSM Response Surface Modelling

Culture Media (CM) may be manufactured using manual labor or automated systems. It may be beneficial to use Quality-by-Design (QbD) strategies and to move away from manual labour towards full automation of a cell manufacturing pipeline in order to meet the rapidly growing demand for clinical grade cell CM around the world. In some embodiments, the performance of a system using a search algorithm that combines machine learning and Differential Evolution (DE) strategies was evaluated for the high-dimensional optimization of complex formulations and HiDiNeu performance was compared with previous approaches, such as DE alone and High-Dimensionality Differential Evolution (HDDE). For ease of reference here, references to “HDDE” should be understood to refer to HDDE without any machine learning modeling pipeline, whereas references to “HiDiNeu” should be understood to refer to HDDE with a modeling pipeline which incorporates machine learning techniques.

In some embodiments, comparisons between DE, DE upgraded with a memory module (HDDE) and HiDiNeu were performed in silico, using computer-based simulations of cell culture processes. Subsequently, a comparison was performed in vitro to assess creating cost-effective chemically-defined formulations that can support the proliferation of human T cells in culture. In some embodiments, for in silico validation, different benchmark functions were used to model response surfaces that were analogous to a representation of the combined effects, within a cell culture medium formulation, of at least 14 different factors at 3 to 5 doses on cell expansion in culture. Since each benchmark function has a known numerical solution (i.e., maxima) that can be used as a reference, the performance of different versions of search algorithms were evaluated by calculating the discrepancy (i.e., error) between the reference and the solution found.

As explained herein, the comparison revealed that when ML techniques were incorporated into Differential Evolution (i.e. HiDiNeu), the solution error decreased by at least 48% and up to 74% compared with DE alone. Moreover, this improvement (or reduction in error) was achieved by sampling less than 5×10⁻⁶% of the total search space. These results indicate that a DE algorithm with ML modelling capabilities can identify better final medium formulations supporting in vitro cell manufacturing and reduce the experimental costs in terms of reagents, time and labour expended.

For in vitro validation, the best formulation was identified with HDDE in six generations (i.e. six iterations) in a published T cell culture study (Kim and Audet, 2019). This formulation was used as an internal control to benchmark all formulations created by HiDiNeu in up to four generations (i.e. four iterations). For the in vitro study, the machine learning module in HiDiNeu was based on a Random Forest model. By the 4^{th} generation in vitro, HiDiNeu created 14 formulations that supported similar or greater T cell proliferation compared with the best formulation identified with HDDE in six generations. Moreover, by matching internal control conditions present in the HDDE experiment and the HiDiNeu experiment, it was possible to infer that, after five generations, HDDE had identified only two formulations that performed as well for supporting T cell proliferation, as compared to the 14 formulations discovered after only four generation by HiDiNeu. Thus, in some embodiments, systems incorporating HiDiNeu techniques may reduce the number of generations required to achieve formulations relative to HDDE techniques, and/or may identify a greater number of formulations which satisfy a particular performance metric relative to HDDE techniques.

Growing interest in commercializing cell-based therapy products (CTPs) is uncovering different types of challenges in the biomedical industry. The recent decade has seen a doubling in the demand for CTPs in North America and Europe and is expected to grow even faster as the demand in Asia begins to increase [1]. CTPs have certain desirable properties compared with traditional chemical-based therapies, including but not limited to i) the possibility to engineer immune cells to specifically target and destroy diseased tissue helps improve potency while decreasing overall strength (concentration of active ingredient), ii) the ability to engineer novel functions into CTPs expands their possible application, and iii) the use of patient-specific cells helps alleviate rejection concerns if in vitro purity is appropriate.

While the above are encouraging developments, translating CTPs from the bench to bedside has remained a significant challenge. A perspective by Lipsitz et. al. argues for the application of quality-by-design (QbD) principles to develop a cell manufacturing pipeline that is consistent with demands of regulatory agencies [2,3]. Some embodiments described herein may facilitate and support development of therapy-dependent Quality Target Product Profiles (QTPP), which describe properties of different CTPs along multiple major objectives such as potency, identity, purity and/or general cell expansion to meet the target dose demand.

In addition to the application of QbD principles, cell-based manufacturing may be improved through the development of a fully automated CTP production pipeline. Automated science has been the focus of many previous publications and research efforts, particularly in the past two decades [4-7]. One of the goals of an automated CTP pipeline is to develop a fully closed loop that requires minimal to no human technician intervention, which implies reduced reliance on technical expertise and trained personnel in specialized domains, as the knowledge can be productionized and encoded in algorithms [7,8]. In some embodiments, a closed loop system may prevent or reduce contaminations from potentially appearing in the final products due to human error in the production pipeline, and so this may help reduce the regulatory requirements in proving purity, and identity, and shift the associated costs of such efforts to the initial development effort to show the complete process operates as expected.

A current hurdle in CTP manufacturing is reproducibility and batch variance due to use of off-the-shelf cell culture media (CM) formulations. CM formulations are typically necessary when supporting the expansion, differentiation, or maintenance of cells outside the human body. Most current gold-standard CMs are serum (animal)-containing formulations that are not suitable in a clinical setting without procedures for the purification and extensive testing to establish that no cross-species contaminants or microbes are present in the final CTP. It would be desirable to develop animal-free, fully-chemically-defined CM formulations. However, their development has historically required significant resources, time, and the training of subject matter expertise in many domains (i.e., cell manufacture engineering, design of experiments (DOE), biochemical and cellular network analysis). Moreover, final CM products typically must be adapted to each cell type, which increases costs even further with each additional cell type. The ability to automate and introduce efficiencies in the development of CM formulations would represent a significant benefit to supporting the development of CTPs in a QbD manner. While it would be advantageous to have access to deterministic models that can be used to rationally design and guide development of custom CM formulations, the development of such differential models that capture the full complexity of each cell type has historically been a long and expensive process that may take many more decades to realize. As such, other strategies, such as alternative black-box heuristics such as global search optimizations, may represent more practical solutions at the present time.

Previous efforts [9-11] towards biological optimization problems have benefited greatly from using global search optimization algorithms, such as genetic or differential evolutionary (DE) algorithms [12] that make no underlying assumptions about the response surface of the desired model system. These global optimization algorithms rely on meta-heuristics to define general guidelines towards optimizing finite formulations as individuals within populations towards some desired objective (e.g., cell expansion, or promoting differentiation towards desired cell types)[11].

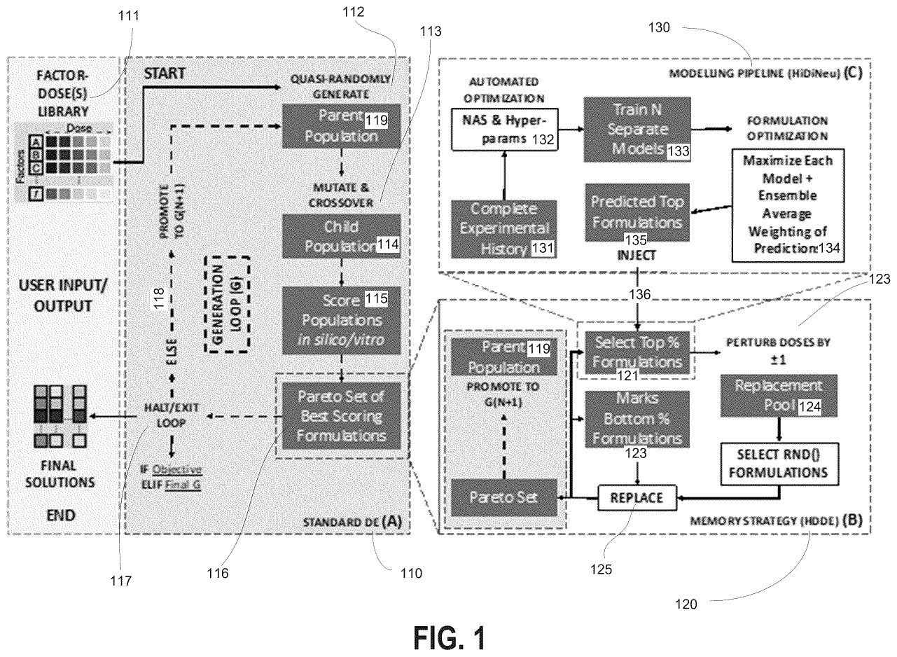

FIG. 1 is a schematic diagram depicting operation of an example system incorporating a High-Dimensional Differential Evolution (HDDE) with machine learning modelling (HiDiNeu) approach, in accordance with some embodiments.

In FIG. 1, three approaches with increasing complexity are depicted, namely the Differential Evolutionary (DE) method 110, the High-Dimensional Differential-Evolution (HDDE) strategy 120, and the HDDE with Machine Learning modeling pipeline (referred to herein as “HiDiNeu”) strategy 130. Block 110 depicts the Standard Differential Evolutionary (DE) algorithm introduced by Storn and Price (1997)[12], which begins with user input 111 as a library of factors and corresponding coded-dose levels. In some embodiments, the algorithm starts by quasi-randomly generating the initial parent population 112. At 113, each parent then undergoes crossover with the mutation product of three randomly selected other parents to generate the child population 114. The formulations are scored at 115, and winners are selected into the pareto set 116. At block 117, if halting conditions fail, the algorithm proceeds with the next generation, promoting the pareto set as the parent population at block 118.

Block 120 depicts the High-Dimensional Differential-Evolution (HDDE) algorithm by Kim and Audet (2019)[11], which introduced the memory strategy into the pareto set 116 selection. In some embodiments, the user defines a top threshold (e.g. 10%, although other threshold values are contemplated), which sets a filter for selecting the Top Scoring formulations 121 in each generation, while also marking the Bottom Scoring formulations 123. As depicted, at block 122 the Top Scoring formulations 121 are perturbed by +/−1 dose-level of each factor to create a replacement pool 124 (with previously tested and non-unique formulations removed). At block 125, randomly selected formulations from replacement pool 124 are used to replace the marked Bottom Scoring formulations 123 within the pareto set 116.

Block 130 depicts the HiDiNeu strategy, which is intended to improve accuracy and accelerate the identification of the best scoring formulations 131 in earlier generations 131. The HiDiNeu strategy includes a modelling pipeline (MP) which injects predicted top formulations 135 into the top formulations 121 of the HDDE strategy. In some embodiments, this fully automated system 130 may perform a machine learning architecture search (MLS) and hyper-parameter optimization at block 132, train an ensemble of N separate models at block 133, maximize the predicted top formulations at block 134, and inject, at block 136, these predicted top formulations 135 into the Top Scoring formulations list 121 for the memory strategies.

Global optimization techniques, such as Differential Evolution 110, while successful in optimizing novel high-dimensional chemotherapies or biochemical pathways[13], may, at times, require many hundreds of experiments (i.e. generations) and have been shown to struggle with multi-objective optimization, particularly when above 3 objectives or tasks[14]. In addition, in contrast with traditional DOE, it is normally impossible to determine if the solutions found by global optimization techniques are global maxima. Previous efforts by Kim and Audet[11] focused on modifying the original DE algorithm with a memory module that combined deterministic mechanisms with the standard stochastic genetic operators; this algorithm was named the High-Dimensional Differential-Evolution (HDDE)[11]. In block 120, in the memory module, current identified top formulations from the pareto set 116 are perturbed to replace the bottom scoring formulations 123 in each generation. In some embodiments, the memory module acts as a global memory pool and can deterministically guide towards highly effective CM formulations in, for example, only 6 generations, while testing less than 1×10⁻⁵% of the total search space. HDDE 120, which was experimentally validated on engineered CAR-T cells and TF-1 cells[11], has identified at least three completely serum (animal)-free cell CM formulations for in vitro cell expansion competitive with the gold standard serum-containing formulations as measured on donor cells. However, for certain biological assays and/or cell types, 6 generations may require over 2,100 individual experiments, which is a significant time and resource investment. Moreover, it is also not known after six generations if HDDE system 120 has identified the global best formulation. The lack of diversity in the final formulations may indicate the existence of one distinct maxima (solutions). Alternatively, because of the stochastic nature of HDDE, there is a risk that the memory module may hovers around the first best-identified formulation lineage. This classical problem, referred to as being “trapped” in a local optimum or mode, may be circumvented with modelling[14].

Previous efforts have applied traditional response surface methodology (RSM) models (i.e., quadratic, and partial cubic) to datasets collected by HDDE 120. These efforts are constrained, as DOE experiences difficulties with greater than eight factors, and no designs exist for systems that require optimization with 10+ factors at 6-dose levels each (for example, the TF-1 and CAR-T cell datasets were optimized at 15 and 14 factors, respectively, with greater than 6×10^{\hat{ }9} total search spaces)[11].

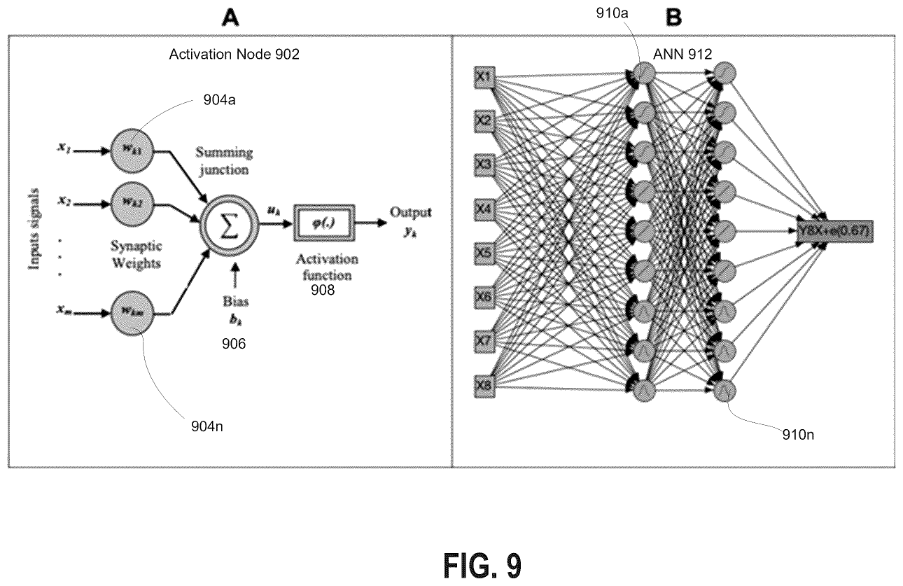

The literature provides examples of optimization problems[13,15-22] resolved by use of modern deep artificial neural networks (ANNs), which may operate as non-linear transformers, handle noisy, missing, or unbalanced datasets better, and can adapt to any number of input factors[15](a depicted, for example, in FIG. 9). ANNs have been successfully applied to the identification of a new antibiotic ab initio, preventing antibiotic resistance in E. coli even after one month of continuous plating[16]. ANNs have been used in chemical engineering processes to improve extraction yields[17], optimize multi-objective bioprocess production pipelines[13], designing novel genetic circuits[18], and mapping new regions of high interest in bacterial genomes[19]. In most examples where traditional Design of Experiments (DOE) techniques have had great difficulty scaling up or could not be applied, ANNs have successfully been applied with reduced effort on the part of researchers [20-22]. Thus, it may be possible that application of automated modelling in the form of ANNs (or, more generally, the application of Machine Learning (ML) techniques) towards the DE algorithm, may significantly reduce total experimental costs, while facilitating identifying final top cell CM formulations that are much closer to the true optimums in the underlying total search space.

Previous efforts [11] included modifying the DE algorithm [12] with a memory module that allowed for the successful optimization of serum-free, chemically defined cell culture media (CM). Using this modified DE algorithm (i.e. HDDE) allowed for the successful identification of five culture media formulations that supported cell expansion of CAR T-cells in three donors. HDDE accomplished this in only six generations, which amounted to in excess of 2,100 total in vitro experiments.

To further support the efficiency gains in adapting DE search algorithms towards biological optimization, some embodiments implement machine learning models. Model-accelerated DE algorithms may identify global best formulations in a more timely and resource-efficient manner. Relative to DE or HDDE strategies, the use of ML models may allow application of search algorithms towards biological optimization problems that are currently prohibitively expensive due to the labour and resource costs associated therewith.

In some examples, integrating machine learning models into the high-dimensional differential-evolutionary (HDDE) operations may increase operational efficiency as compared to conducting operations using HDDE strategies alone.

In some embodiments, integration of machine learning models uses data from earlier generation(s) to predict improved formulations as replacements for poorly performing recipes. In the practical context in which some embodiments are used, increased efficiency means that, for the same experimental cost, HDDE with machine learning modelling (HiDiNeu) may identify cell culture formulations that are closer to the global maxima compared to formulations identified by HDDE alone. Alternatively, increased efficiency may allow the HiDiNeu approach to identify formulations that support a level of a desired or target cell response (e.g., expansion) that is similar to the level of a formulation obtained by HDDE alone, while incurring a lower experimental cost. In some embodiments, the HiDiNeu approach uses the first generations of data to predict formulation replacements as early as in a second generation, which may result in formulations created in a third and fourth generation that may score as highly or better as formulations identified by HDDE in six generations.

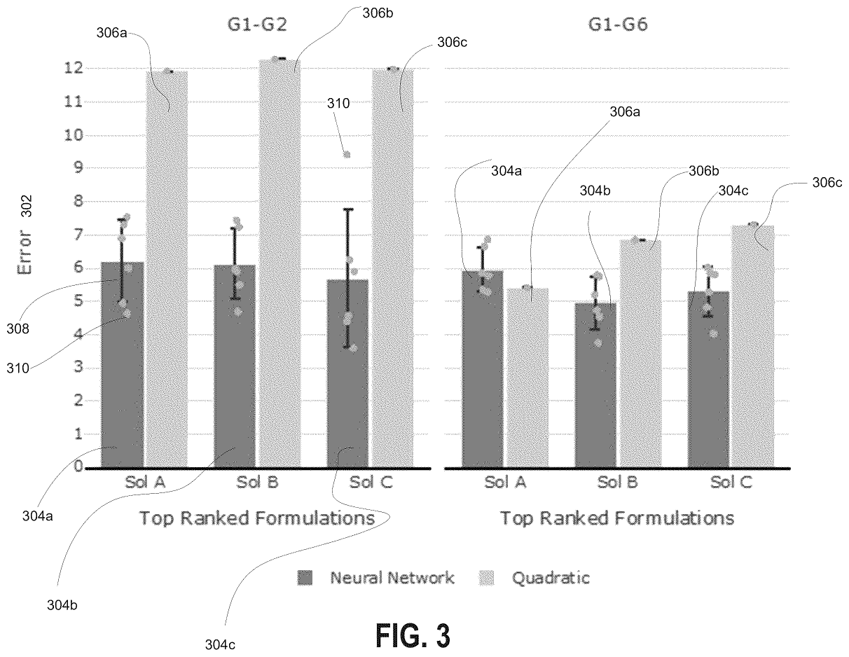

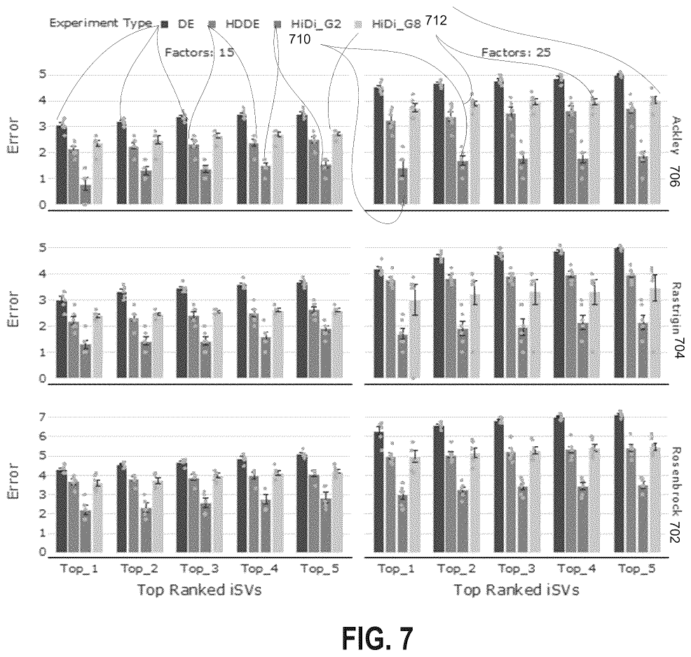

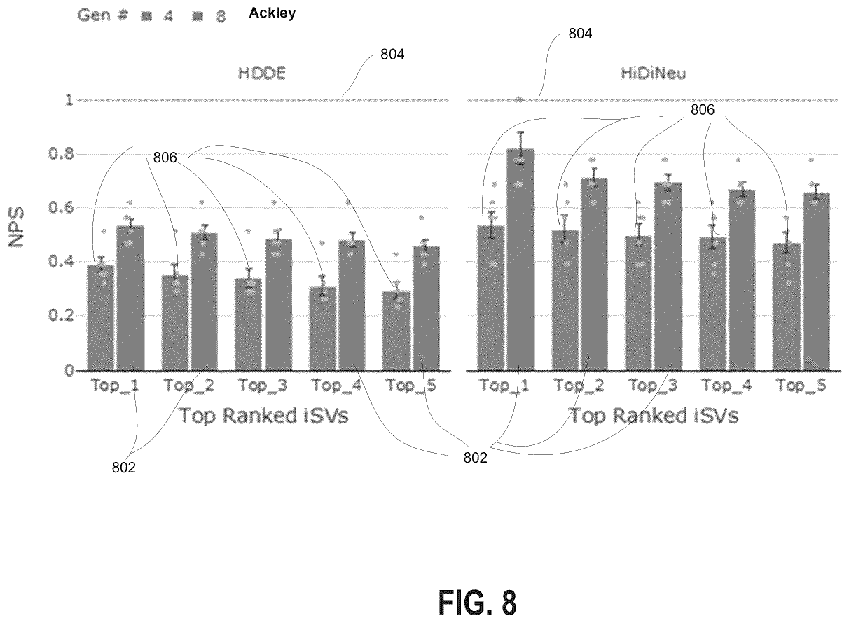

In some embodiments, systems incorporating HiDiNeu techniques may allow for a reduced investment of time and resources, thereby reducing the overall experimental cost. Moreover, in some embodiments, when systems incorporating HiDiNeu techniques are allowed to run for longer periods, such systems may identify better scoring formulations. As depicted in FIGS. 7 and 8, in the context of standard benchmark functions that approximate biological conditions and post-hoc analysis of cell expansion datasets previously collected, the use of HiDiNeu systems may result in formulations with superior performance (see, e.g., FIG. 3).

In some embodiments, post-hoc analysis of published experimental T cell CM data suggests that machine learning modeling can accelerate the process of identifying improved formulations.

In a previous study in our lab [11], an HDDE system was applied towards the optimization of a 14-factor, chemically-defined CM formulation to support the objective of maximal cell expansion of engineered CAR-T cells. The HDDE system ran for just over 2,100 experiments spread over 6 generations. The final top five formulations identified were then experimentally validated on T cells taken from multiple donors. These formulations were able to promote cell expansion levels similar to the current gold-standard serum-containing culture medium and showed minimal biological variance between donors [11]. The final top three formulations were used as reference formulations, referred to herein as Top Ranked Formulations (i.e., Solutions A, B and C).

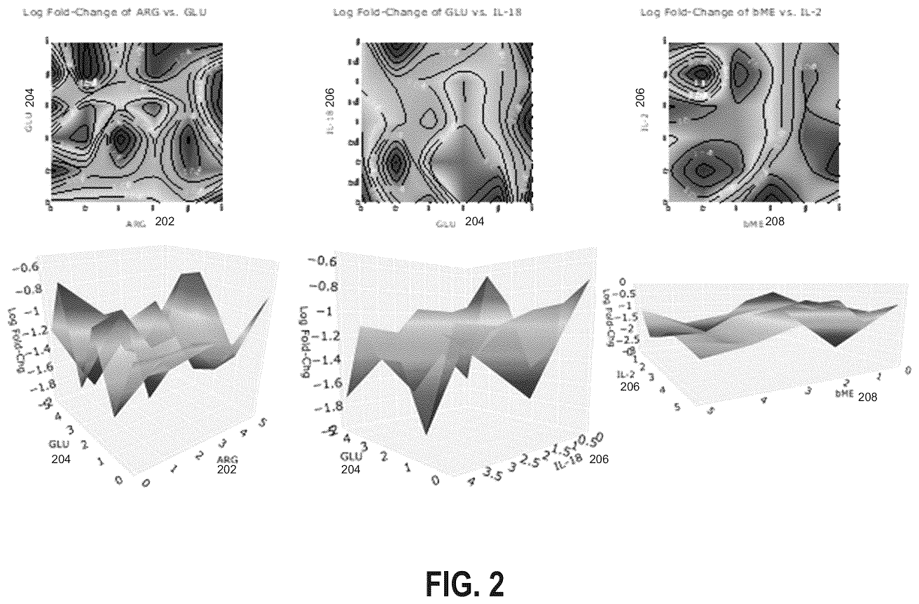

Previously, post-hoc analysis performed [11] on collected data using HDDE systems suffered from difficulty in fitting traditional quadratic Response Surface Method (RSM) models. Such difficulties are expected, as FIG. 2 depicts the response surfaces of the raw data of some factor-interactions. Many of the response surfaces depicted in FIG. 2 (e.g. arginine and glutamine interactions) indicate a much rougher terrain that is difficult or even impossible to model with simple quadratic assumptions.

FIG. 2 illustrates contour and response surface plots to illustrate a select subset of the multiple factor interactions using experimental data collected on T cell expansion guided by HDDE [11]. As depicted, ARG 202 connotes arginine, GLU 204 connotes glutamine, IL 206 connotes interleukin, and bME 208 connotes beta-mercaptoethanol. Fold-change data on T cell expansion was used to plot contour and 3D response surface plots of a subset of factor interactions. The factors above were shown in previous post-hoc analysis[11] to be some of the highly significant positive or negative strength effects. Due to the complex topography of the response surfaces as shown in FIG. 2, a traditional quadratic model fitting is not suitable or possible. In some embodiments, more powerful modelling systems, such as those incorporating machine learning may capture the response surface of such experimental data better, especially at earlier generations.

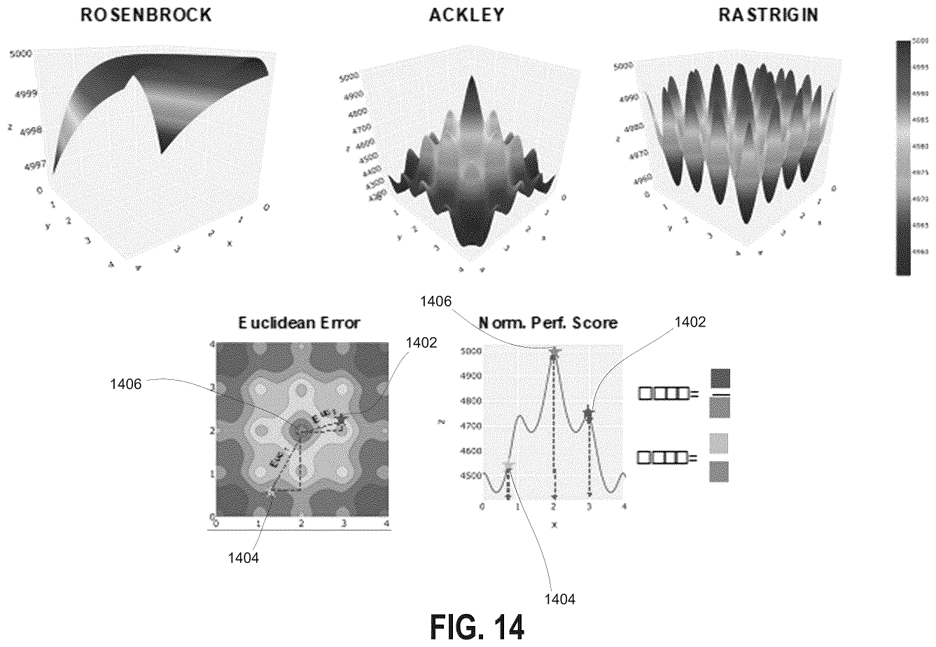

In some embodiments, machine learning modelling may be used to speed up the identification of suitable formulations in combination with an HDDE system. A system incorporating ANNs with the JMP Pro 14 modelling platform using the first 2 generations of data (G1-G2), and as comparison models built with all the collected data (i.e., 6 generations, G1-G6). For these in silico experiments, simple traditional quadratic RSMs (as described by Equation 2 described further below herein) were used as a negative control, as they were expected to be too simple to significantly accelerate the search process. Predicted best formulations were then optimized using the JMP Pro 14 prediction profiler platform, with both ANN and quadratic models. Formulations predicted by each of the ANN and quadratic models to support greatest cell expansions were then compared with the Top Ranked Formulations A, B, C previously mentioned. Specifically, the formulations found by the ANN and quadratic models were scored relative to the Top Ranked Formulations using a L2 norm [23] metric (see, e.g., FIG. 14) referred to as error 302 in FIG. 3). As depicted in FIG. 3, when using relatively very small amounts of data (as represented by the first 2 generations; G1-G2) it is clear that formulations optimized by ANNs 304a, 304b, 304c score with an error at least 50% below those formulations optimized by quadratic RSMs 306a, 306b, 306c (n=6 replicates). However, the quadratic models 306 do catch up to the ANNs 304 when more data is added (see, e.g., G1-G6, right panel FIG. 3).

FIG. 3 is a depiction of error scores based on the L2 norm being smaller in ANN-model-optimized formulations compared to traditional quadratic models. Data was collected using HDDE with the objective of cell culture media formulations that maximally expanded T cells in vitro [11]. From 6 total generations of HDDE Top 3 Formulations 304a, 304b, 304c were identified and experimentally validated by expanding T cells from different donor patients. In JMP Pro 14, Artificial Neural Networks (ANNs) and traditional quadratic response surface models (RSM) were trained on first 2 generations of data (G1-G2) and on 6 generations of data (G1-G6). Both the ANN and quadratic models were then used to optimize predicted formulations using the JMP Pro 14 Prediction Profiler platform. As can be seen in FIG. 3, ANN optimized formulations 304a, 304b, 304c using G1-G2 data scored lower error than predicted formulations from RSM models 306a, 306b, 306c, however RSM models 306 catch up when 6 generations of data are included. However, predictions from ANN models trained on generations G1-G6 did not score appreciably lower error relative to generations G1-G2, which may indicate that formulations 304a, 304b, 304c might not be the best possible in the total search space of the 14 factors being optimized. It will be appreciated that in FIG. 3, bar plots 308 show mean±SD of n=6 replicates, with replicate data points 310 also illustrated.

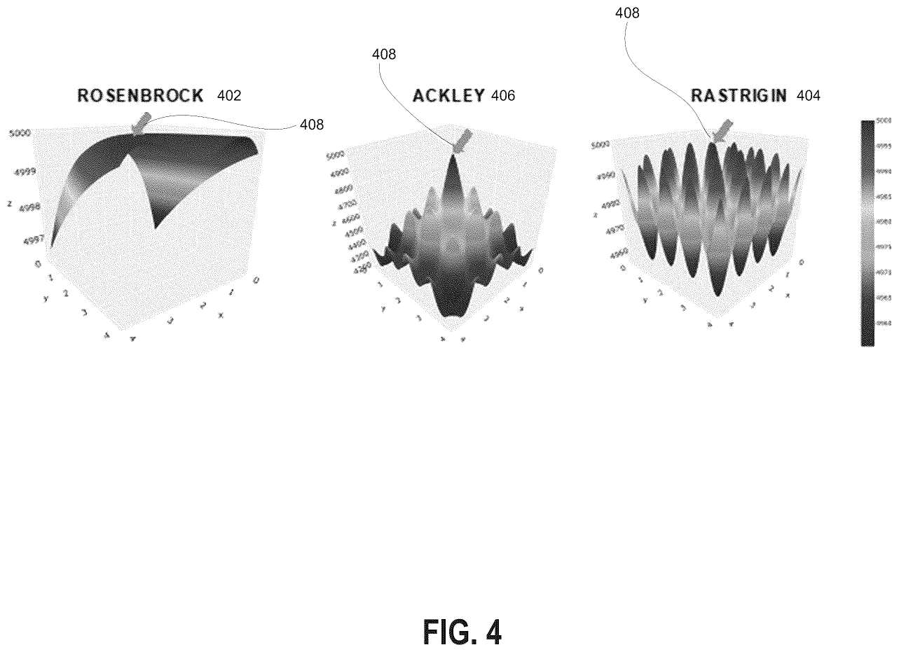

Based on FIG. 3, it is clear that more generational data (e.g. G1-G6 vs. G1-G2) does not seem to help the ANNs reduce their error scores 302 as measured by L2 norm, relative to the experimentally validated top formulations. Instead, more data helps to reduce the variation in predicted formulations (as illustrated by narrower error whiskers on the bar plots 308 in FIG. 3). A possible explanation is that the ANNs, after fitting only 2 initial generations of data G1-G2, have identified formulations that could outperform the formulations previously identified with HDDE (i.e., the Top Ranked formulations) (Sol A-Sol C). However, this is an interpretation that might not be verifiable in vitro, as the total search space is too vast and the reagents are too expensive. Therefore, in some embodiments, high-dimensional standard benchmark functions [12,24,25] have been used (see, e.g., FIG. 4), for which global Top Formulations (i.e., global maxima) are known and well-studied. Therefore, for the next in silico experiments described herein, these known global maxima are used as references to measure the effectiveness and efficiency of HiDiNeu systems to identify the solutions, referred to herein as in silico Solution-Vectors (iSVs) of the benchmark functions. Specifically, results are depicted below for the HDDE [11] approach, modified with a fully automated modelling pipeline strategy that requires no modelling expertise by the user. In some embodiments, the accuracy and efficiency of this new algorithm (the HiDiNeu approach) is documented on three standard benchmark functions, namely the Rosenbrock function (as defined by Equation 3 herein)[26], the Ackley function (as defined by Equation 5 herein)[27], and the Rastrigin function (as defined by Equation 4 herein)[28].

FIG. 4 illustrates plots of the Rosenbrock 402, Rastrigin 404, and Ackley 406 benchmark functions modified towards biologically relevant optimization. Arrows 408 indicate the known global maxima solution. The original responses of each benchmark functions are shifted, scaled, and inverted to change the objective from a minimization to a maximization problem (in order to simplify the description of the results). Response surfaces show 2 dimensions (factors) only with response in z-axis, however the above functions allow for an unbounded number of dimensions, thus enabling difficulty of optimization quite naturally. The modified Rosenbrock 402 has a maximum at a vector of 3 dose levels, modified Ackley 406 and Rastrigin 404 both have a maximum at a vector of 2 dose levels.

While the JMP Pro 14 ANN platform, used in the previous section, may automate the training hyperparameter optimization search, the JMP Pro 14 ANN platform does not perform an automated Neural Architecture Search (NAS) or Machine Learning Architecture Search (MLAS). To develop a fully automated modelling platform in HiDiNeu, and support open-source software, some embodiments of an HDDE system were re-written in the Python programming language. In some embodiments, HiDiNeu's modelling pipeline is configured toy accept experimental data and select the ideal neural or machine learning architecture itself. In some embodiments incorporating ANNs, HiDiNeu may training hyperparameters itself.

Some embodiments of an HiDiNeu system comprise a new Modelling Pipeline module. In some embodiments, the modelling pipeline is implemented in 2 phases. In some embodiments, one or both of the phases are fully automated. In some embodiments, Phase 1 performs the NAS or MLAS and/or training hyperparameters optimization; producing a final trained ANN or ML model that it then passes to the next phase. In some embodiments, Phase 2 uses the newly trained ANN and/or ML models to maximize formulations (or iSVs for reported experimental results below) that should perform better in the subsequent generation. In some embodiments, one or both of Phases 1 and 2 may be programmed to require minimal or no researcher input to operate.

In some embodiments, Phase 1 of the modelling pipeline includes automated NAS or MLAS and/or Hyperparameter Optimization, which may train models based on limited data that can generalize well to unseen data in a total search space.

It will be appreciated that ANNs are highly nonlinear models and their complexity is controlled by two hyperparameters referred to as the depth and width of the neural architecture [29]. The width is controlled by the number of nonlinear activation functions that gate each node in the network, while the depth is controlled by the number of individual hidden layers each containing a certain number of fully connected nodes [30,31]. The training of ANNs refers to the adjustment of weights controlling the amplitude of the activation function outputs, which is ultimately how the ANNs “learn” to model the response surface, training is itself controlled by separate hyperparameters such as the learning rate and regularization factor which require optimization for each dataset [29,32,33]. Traditionally these two different sets of hyperparameters are referred to as the NAS and training-hyperparameter optimization, and rely on the direct input and expertise of human engineers to fine tune, in spite of significant effort having been invested into automating these processes. HiDiNeu's MP relies on the best practices identified in the literature [34-37] over the last decade to remove the need for direct experimenter/technician input.

In some embodiments, the HiDiNeu MP uses the Optuna framework [38] in Python to implement both NAS and training hyperparameter optimization. Optuna uses a Tree Parzen Estimator [38] to design experimental runs that are efficient but effective in capturing the most information on Expected Improvement. Using this information in each cycle of experimental designs (i.e. designated trials in Optuna), probabilistic models identify regions (in hyperparameter space) of high uncertainty and maximum Expected Improvement [39] with regard to minimizing the training-validation loss curves, from which the next set of focused experimental designs will be chosen. The use of modelling in a sequential manner is traditionally referred to as Sequential Model-Based Optimization [34,40], and is relied upon in machine learning when the hyperparameter space is too large to be efficiently captured by traditional orthogonal designs, and the underlying response surface has many local optima that cause problems for traditional RSMs.

As depicted in block 130 of FIG. 1, the machine learning architecture and training hyperparameters identified may be used to train multiple replicate models on the same dataset, starting each model from a different set of random initialized weights (sometimes referred to as ensemble ANNs). This has been shown [41,42] to capture the variance effectively in the underlying response surface, as compared to other ANN modelling techniques including Bayesian Neural Networks.

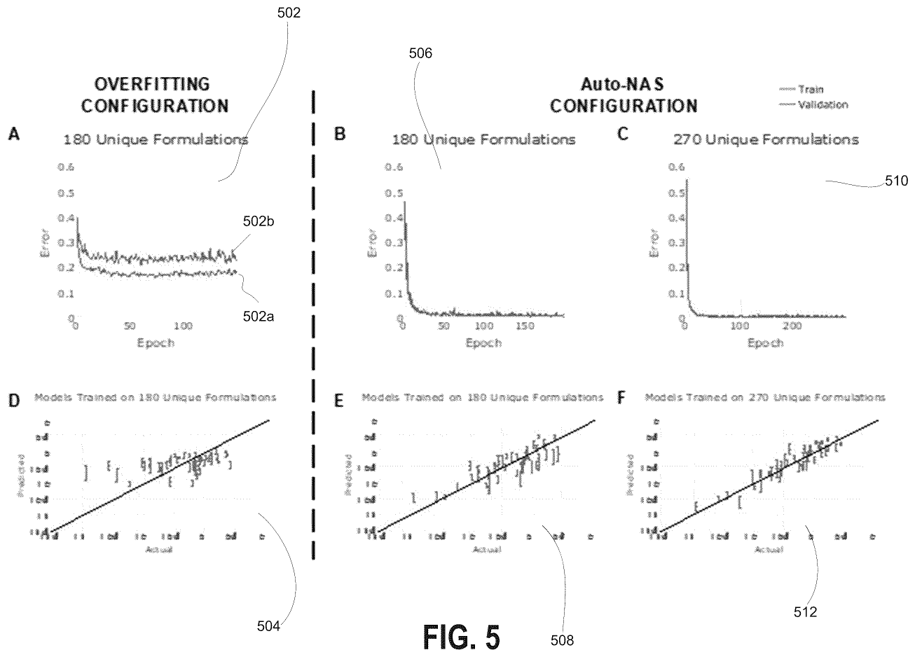

The ability of HiDiNeu's MP to identify optimal hyperparameter configurations was tested using the experimental set up and results shown in FIG. 5. A randomly sampled test set of 100 unique formulations and their true normalized scores were set aside (i.e. not used for training/validation) and only used once at the end. 180 and 270 unique formulations were randomly sampled as the training data, representing 2 and 3 generations respectively for a 15-factor optimization problem. The training data was internally split into training and validation splits using either a hold-out strategy or k-fold strategy as chosen by the user. In FIG. 5, chart 502 plots the training-validation loss curves for 5 ANN replicate models that were trained using hyperparameters randomly sampled from literature-suggested hyperparameter ranges for a regression ANN [29]. As depicted, the training curve 502a is lower than the validation curve 502b, indicating an example of overfitting models, which is highly undesirable. The standard deviation curves are very wide, indicating high uncertainty and low generalization between replicates of the same hyperparameter configurations. This is seen in chart 504, where the 100-data test set is used to plot the Actual-vs-Predicted (AVP) plot, predicted values fall far from the ground truth line forming a flat line trend. Charts 506 and 508 plot training loss curves for 5 ANN models trained using the MPs automatically identified hyperparameter configurations. Training and validation loss curves trend together, indicating no over-fitting or under-fitting. In chart 510, the predicted normalized scores revolve around the ground truth much better, which indicate the MP has identified hyperparameter configurations that train reproducible and generalizable replicate ANN models using the same data as in chart 502. In chart 512, using an ensemble of 5 ANN models trained on a slightly larger dataset (approximately 3 generations worth) leads to better AVP profiles, with uncertainty estimates narrowing in data points that score high (the desired formulation region). As such, models trained with HiDiNeu's MP may be trusted to uncover a good representation of the underlying response surface. To conclude, the factor problem space for a 15-factor 5-dose level space represents over 3.0×10¹⁰ total possible combinations, while the 270 unique formulations the models were built on only represent 9.0×10⁻⁷% unique formulations of the total space. Although these are very small subset datasets, it can be seen that the MP can train models to generalize sufficiently well in these sparse conditions.

In some embodiments, a goal of the Modeling Pipeline is to use models starting from generation 2 or 3 to predict best performing formulations. These best performing formulations would traditionally be identified, with conventional HDDE, in much later generations—or possibly never—in the available experimental timeframe. Using machine learning modelling may allow access to the underlying patterns of the true response surface, which can then be searched (i.e. maximized) to identify regions of highly scoring formulations. These formulations may then be injected into a replacement pool as part of the HDDE memory strategy from which replacements can be selected into the parent population, in place of poorly performing formulations, thereby increasing scores of the final identified formulations.

Identifying formulations predicted to score highest in experimental conditions (referred to herein as “maximizing the response”), requires implementation of a suitable maximization technique. Conventional versions of a DE algorithm [12] were tested in silico against other methods. It was assumed that due to the population-based nature of DE, DE would perform the best in identifying a set of predicted top scoring formulations. As ANNs are a smooth function, an iterative gradient descent technique, the Broyden-Fletcher-Goldfarb-Shanno (BFGS)[43] algorithm, and a technique combining global and local optimization called Basin-Hopping [44] were tested. It should be noted that for in vitro tests, the Optuna framework (that is also used for hyperparameter optimization) was used rather than Basin-Hopping.

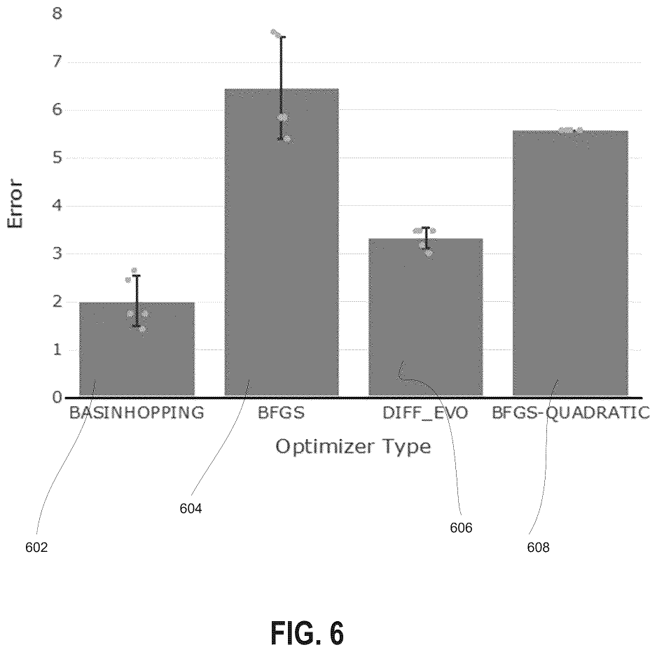

The results of in silico testing were collected by training ANN models on the first 2 generations (i.e. 180 unique formulations) of collected data for the Rosenbrock model at 15-factors, maximizing in multiple separate runs and then averaging, in a simple ensemble fashion, the results across the dose levels. This approach represented a “vote by majority” for each factor-dose position. As a comparison of the ANN models with traditional DOE, quadratic RSMs (as defined by Equation 2 herein) were trained and maximized to identify the predicted high scoring formulations, with data plotted in FIG. 6.

Somewhat unexpectedly, the Basin-Hopping algorithm performed best when maximizing models in ensemble fashion. As depicted in FIG. 6, the error (y-scale) references a L2 norm (as defined in Equation 1 herein) which takes the square root of the sum of squared error residuals of each predicted top formulation from the true known maxima. As depicted, the mean of the Basin-Hopping algorithm 602 is the lowest of all other maximization techniques, and with only 2 generations of data, the traditional quadratic RSM 608 fails to perform adequately, coming in third place. With a much larger parameter space in which the possible formulation space grows exponentially, while experimental data grows by linearly (3*D, see Kim & Audet, 2019[11]), the quadratic model would be expected to deteriorate quickly.

FIG. 6 illustrates the Error score (relative to the solution of the Rosenbrock function) based on an L2 norm of predicted top formulations for different maximization algorithms. Final trained artificial neural networks (ANNs) should be maximized (i.e., identifying the formulations that are predicted to score the highest). To compare the capabilities of different maximizing algorithms, multiple ANNs were built using HiDiNeu's modelling pipeline (on experimental data generated with the Rosenbrock function), and then each model was executed on a different maximizer from Basin-Hopping 602, BFGS 604, and differential evolution 606. These capabilities were also compared to a more traditional RSM technique 608 using quadratic models that were maximized using the BFGS algorithm. As depicted, FIG. 6 shows the Basin-Hopping 602 to be the most effective and efficient algorithm to identify predicted top formulations with ANN models built using the modelling pipeline. (n=5 replicates, mean±SD shown).

Notably, the in silico Solution-Vectors (iSVs) (i.e. top formulations from simulations) identified by HiDiNeu had at least a 40% decrease in error scores compared to HDDE, and up to a 75% decrease compared with DE.

FIG. 7 presents in silico experimental data that was collected for each standard benchmark function (Rosenbrock 702, Rastrigin 704, and Ackley 706) in 6 separate runs at a low (15-factors), medium (20-factors, not-shown) and high (25-factors) dimensional problem spaces for 3 different levels of noise (10%, 30%, and 70% CV, refer to supplementary figures for higher noise levels) to simulate biological variance. The medium noise level was chosen based on variance observed in previously collected in vitro data. The lowest and highest noise levels were then computed approximately as half and double this observed variance. In FIG. 7, the leftmost bars represent the original DE algorithm [12], the second from the left bars represent the HDDE algorithm[11], and the two right-most bars represent the novel HDDE with machine learning modelling pipeline (HiDiNeu) technique. The error scale represents the L2 norm error (Equation (1)) which takes the square root of the sum of squared error residuals of each identified top iSV from the true known global maxima (As depicted, for example, in FIG. 14).

Table 1 (below) presents the L2 norm error scores and average improvement (i.e. the decrease in error) of HiDiNeu relative to original differential evolution (DE) and HDDE algorithms when simulating a biological process affected by formulations containing either 15 or 25 ingredients (factors).

| # | | | | | HDDE/DE | HiDiNeu/DE | HiDiNeu/HDDE |
|---|---|---|---|---|---|---|---|
| Factors | Function | DE | HDDE | HiDiNeu | Improvement | Improvement | Improvement |
| 15 | Rosenbrock | 4.278 | 3.676 | 2.230 | 14% | 48% | 39%* |
| | Rastrigin | 3.012 | 2.208 | 1.305 | 27% | 57% | 41% |
| | Ackley | 3.074 | 2.145 | 0.805 | 30% | 74%* | 62% |
| 25 | Rosenbrock | 6.291 | 4.988 | 2.989 | 21% | 52% | 40% |
| | Rastrigin | 4.198 | 3.778 | 1.708 | 10% | 59% | 55% |
| | Ackley | 4.505 | 3.270 | 1.405 | 27% | 69% | 57% |

The mean L2 norm error from FIG. 6 for the Top_1 formulation was tabulated, and the percentage improvement (in terms of decreasing the error score) was calculated for HiDiNeu relative to the DE and HDDE. As shown in Table 1, the largest improvement is seen for the Ackley function, where HiDiNeu error drops by 74% over DE, and by 62% over HDDE for a 15-factor space (10% CV). The lowest improvement occurs for the Rosenbrock function, with HiDiNeu improving at least 48% over DE and 39% over HDDE for a 15-factor space. The lowest and highest percentage error decreases of HiDiNeu over either DE or HDDE are marked by asterisks in Table 1.

It is clear from FIG. 7 that the HiDiNeu technique decreases error scores based on an L2 norm (Equation (1)) in final identified top iSVs. In FIG. 7, lower scoring bars are better, as they represent lower error. The L2 norm error (sometimes referred to as Euclidian distance) may be defined as the square root of the sum of squared error measured along each factor-dose level. The HiDiNeu algorithm was run against 3 well-known benchmark functions (Rosenbrock, Rastrigin, and Ackley) at multiple dimension (factor) levels (2 are shown above) for 6 separate runs. The top 5 iSVs (x-axis) were then scored against the true global maxima (see FIG. S6) along their dose levels as a measure of the accuracy (Error, y-axis). The HiDiNeu algorithm (HiDi_G2) decreases the final error of the top iSVs between 50% to 75% for the top 5 iSVs across all 3 benchmark functions. The effect is more pronounced as the dimensionality of the problem increases, where we see final scores similar between the 15 and 25 factor functions, while scores for the original HDDE algorithm increase at the higher dimensionality. This indicates that the modelling pipeline may handle the exponential expansion of the problem space significantly better than the original HDDE algorithm. A negative control experiment designed to assess the efficacy of the MP was performed by activating modelling at generation 8; in that experiment, the effect almost completely disappears (HiDi_G8). (n=6 replicate runs, mean±SD shown, simulated CV=10%).

Unexpectedly, on both Rastrigin and Ackley benchmark functions at 15-factors, the original HDDE algorithm scores relatively well, below an error of 3 on average, for all iSVs in the top 5 positions. This is due to the fact that HDDE can often find a small number of high performing formulations (iSV). However, the mean score of the population will remain lower than that of HiDiNeu. HiDiNeu is a better algorithm to improve the population of formulations as a whole and resulting in the identification of a larger number of ‘hits’. The Rosenbrock function is the only model that experiences error scores above 3 for all top 5 positions in the original DE and HDDE approaches. However, as the dimensionality of the problem increases to 25-factors the errors for identified final iSVs in all 3 benchmark functions increases above 3 on average, surpassing errors of 4 and 5 for Rastrigin and Rosenbrock in certain top iSV positions.

As evident from the red bars 710 (modelling started after generation 2, labelled HiDi_G2 in FIG. 7) in 15- and 25-factor dimensions, the addition of the MP in HiDiNeu drastically helps improve the top result. For all 3 benchmark functions at the 15-factor dimensions the final error scores for most of the top 5 iSVs is under an error of 2 on average, with only the Rosenbrock solutions fluctuating between 2-3 error scores on average. This marks, on average, an improvement in error by at least 48% for most positions in the final identified top 5 iSVs compared with the original DE (and as high as 74% for the top 1 identified iSVs), and at least 40% improvement over HDDE (see Table 1). Interestingly, for both Rastrigin and Ackley in the 25-factor dimension space, the final errors for all top 5 iSVs is under 2 on average. Rosenbrock is the only benchmark function that experiences slight shifts in final errors of the identified top 5 iSVs, however the results for HiDiNeu at 25-factors are still better than even the 15-factor dimension Rosenbrock function using the original HDDE or DE for optimization. Taken together, it is clear that the Modeling Pipeline of HiDiNeu facilitates identification of final top iSVs that are much closer to the true global maxima for all three benchmark functions compared to the original DE [12] and HDDE [11] algorithms.

In some embodiments, HiDiNeu systems will scale-up better than DE and HDDE with exponential increases in the parameter space.

The previous results as presented in FIG. 7 show, on average, at least 50% improvement in the final error of the identified top 1 iSVs when comparing HiDiNeu with DE (at least 40% improvement over HDDE). It is evident that this effect is maintained in both the low (15-factor) dimension space, as well as the high (25-factor) dimension space that were tested. It is possible that this ability may be maintained when scaling the problem domain to much higher dimensions such as 100 or 200-factor problems.

These results are notable in that the scaling difference between the true combinatorial problem space as dimensions increase, and the amount of information collected from experimental data per generation, is stark. For simply adding 10 factors (15 vs 25 factors), the total combinatorial space of possible unique iSVs increases exponentially from approximately 3.0×10¹⁰ options to just under 3.0×10¹⁷ options. Nevertheless, the collected in silico experimental data in each generation only grows by a linear scale (3*D, see Kim and Audet, 2019 [11]), from 45 (15-factors) to 75 (25-factors). It is possible that these outcomes may be maintained to higher dimensions, where this stark difference will be amplified even faster.

In some embodiments, the performance of HiDiNeu is robust in the face of large variance in the response data which is necessary to use this algorithm in biological systems. The previous in silico experiments were conducted with specific response variance parameters to simulate biological noise, which are analogous to the batch-to-batch variance in in vitro cell expansion (i.e., response). This noise may be controlled by a factor set by the experimenter that is unknown to the algorithm during run time [11]. The algorithm uses an internal mechanism to measure the variance of replicates of some positive control formulation in each generation. For in vitro experiments, this would be the current gold standard formulation for a specific biological assay, and for in silico experiments this is usually the global maxima. In addition to the variance tracker, already a part of the original HDDE algorithm, the Modeling Pipeline of HiDiNeu may aim to build models that do not overfit.

Overfitting is an indication that the ANNs or ML models have started to “memorize” the experimental data, rather than of learning to identify the underlying mechanism that created the patterns. Overfitting can be a particularly significant problem for a stochastically guided algorithm, such as HDDE, as it would mean that the models would not generalize particularly well to formulations/iSVs outside of the experimentally validated dataset. Overfitting implies that in the presence of higher levels of noise, predicting true best formulations (in vitro) or global maxima (in silico) would be highly challenging.

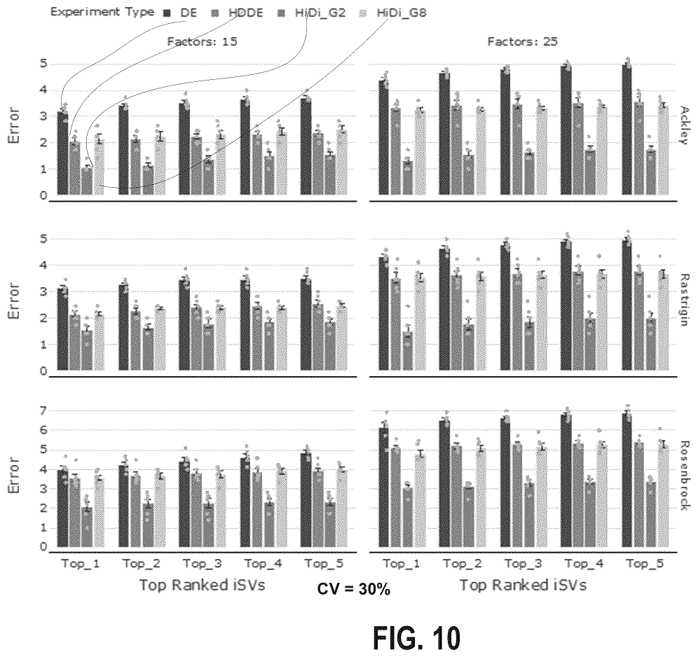

Thus, it is particularly helpful that the previously reported results from above translate over to higher levels of noise (referred to herein as coefficients of variation (CV)). The simulated levels were 10% (low) CV, 30% (medium) and 70% (high). As seen in FIGS. 10 (CV=30%) and 11 (CV=70%), across the 3 benchmarks mentioned before, the results of at least 50% improvement in final errors for the top 5 iSVs identified still held true at the highest level of 70% noise, and was comparable with the low level of 10% noise. The effect is true at high dimension (factor) problems.

As expected with data-based statistical modelling, ANN predictions tend to improve as more data is added and as the dataset is balanced across the different dimensions. Thus, if HiDiNeu operates as the original HDDE for a few generations longer (e.g., beyond generation 2) and activated its modelling capabilities at generation 5, or later at generation 8, this might create better ANNs that can predict the global maxima more accurately, thereby reducing the final errors in the top 5 iSV positions even further.

However, as shown by the results presented in FIGS. 7, 10 and 11, this might not be not necessary. When activation of the Modeling Pipeline in the HiDiNeu algorithm is delayed, the performance may deteriorate to a level like that of the original HDDE algorithm (as shown by bars 712 labelled HiDi_G8 in FIG. 7). These results seem to indicate that while modelling does help to improve (i.e. decrease) the final errors in the top 5 iSVs, this benefit might not immediately manifest once modelling is active. A possible reason for this phenomenon may be that while predicted top iSVs are injected into the replacement pool, their impact is dampened due to the random selection in the memory module.

In some embodiments, when compared with HDDE and DE, HiDiNeu may identify Top iSVs that yield response scores that are closer to the highest response scores achievable. Taking the identified top iSVs from FIG. 7, the original benchmark functions (defined by Equations 3 to 5 herein) may be used to compute the true maximum response corresponding to these iSVs. These responses are analogous to a biological response (e.g. cell expansion) and are expressed as Normalized Performance Scores (NPS) (as defined by Equation 7 herein, with FIG. 14 depicting a graphical example of an NPS). In some embodiments, the NPS is defined as the true score of identified Top iSVs normalized to the global maxima of the benchmark function. In this scenario, a goal is to maximize the NPS to the extent possible. In FIG. 8, the top five iSVs 802 in each separate run, scored them using the original Ackley benchmark function, and normalized them to the global maxima 804 (see dotted line in FIGS. 8 and 14). HiDiNeu's Modeling Pipeline may help to identify iSVs that either reach the true final score (e.g. Top_1 iSV in FIG. 8), or come very close compared with the HDDE's results for any of the top five iSV positions (as shown in FIG. 8).

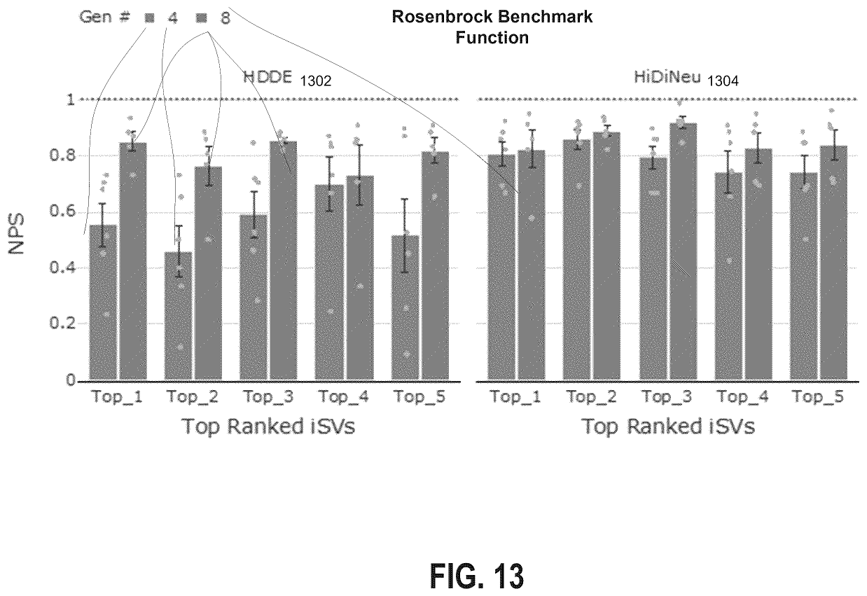

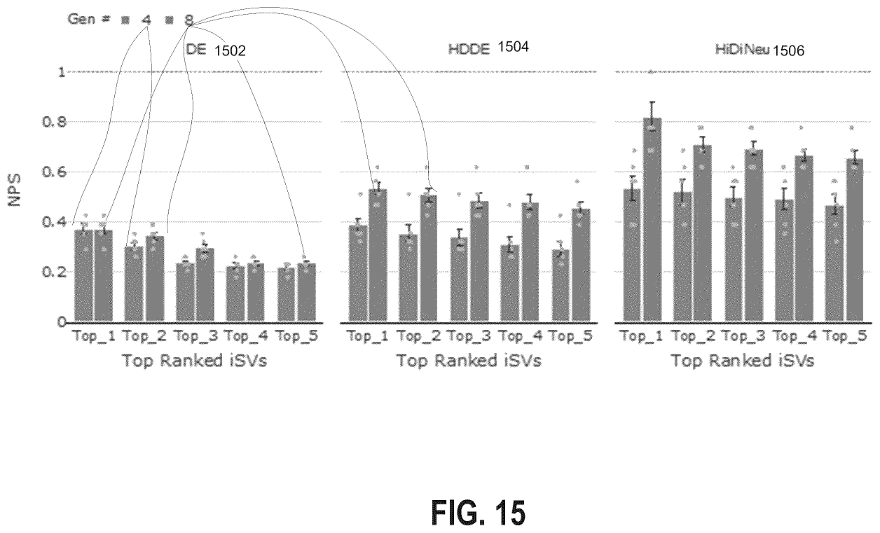

FIG. 8 also presents the top identified iSVs from an earlier generation (G4, as depicted by bars 806 in FIG. 8) in order to compare the performance of HiDiNeu relative to HDDE with only half the number of generations. This represents a scenario in which search algorithms can only run for half the number of generations (thereby incurring half the experimental cost) due to constrained resources or time available. The top five iSVs from G4, identified by HDDE and HiDiNeu, were similarly scored as above and plotted. As depicted in FIG. 8, in only four generations, HDDE has even lower scoring formulations, which is to be expected. However, in only four generations, HiDiNeu identifies iSVs that score as high as those identified by HDDE in eight generations (when comparing HiDiNeu G4 802 with HDDE G8 806) for all top five iSVs. This indicates that modelling from generation 2 onwards may help the HDDE algorithm to identify even better performing formulations in a much shorter time frame compared with HDDE or DE (see FIG. 15). FIGS. 13 and 14 depict results for Rosenbrock and Rastrigin benchmarks. FIGS. 15 to 17 that plots the same data alongside the original DE results to illustrate improvements in performance relative to baseline DE performance.

As noted above, previous work by Kim and Audet [11] has reported on the HDDE algorithm's development and successful optimization of serum (animal)-free CM formulation for the in vitro expansion of TF-1 and CAR-T cells. In some embodiments, the HiDiNeu approach (i.e. the addition of a fully automated Modeling Pipeline using ANNs and/or other Machine Learning (ML) techniques to the HDDE approach) may provide significant improvements.

In some embodiments, one of the goals of the Modeling Pipeline is to use ANNs and/or other machine learning techniques for predicting and identifying better scoring formulations using data from earlier generations. The Modeling Pipeline may be implemented in a fully automated fashion to remove the need for experimenter input. As noted above, in some embodiments, the Modeling Pipeline may be implemented in two distinct phases. In some embodiments, the first phase optimizes the neural and/or machine learning architecture and/or training-hyperparameters. In some embodiments, the second phase may maximize formulations using the ANNs and/or ML models to identify high-scoring formulations supporting the desired objective.

In some embodiments, relative to the three (3) benchmark functions, HiDiNeu may outperform the original DE algorithm by up to 75% and may outperform the HDDE algorithm by at least 50%, decreasing the error for top identified iSVs measured against the global maxima. In some embodiments, HiDiNeu may demonstrate significant robustness to high levels of variance. Thus, some embodiments of the HiDiNeu system may effectively deal with exponentially increasing total search spaces (e.g. 10¹⁰ to 10¹⁷), relative to the HDDE or DE algorithms, for which performance deteriorates more quickly. It is possible that higher numbers of factors with even larger search spaces may benefit from the use of HiDiNeu systems.

It should be noted that in silico results based on benchmark functions might not always be accurate representations of in vitro tests. However, in vitro experimental confirmation for some embodiments has been obtained and is described further below. Moreover, it is important to note that previous work by Kim and Audet [11] similarly initially used the Rosenbrock benchmark function for in silico validation of the HDDE algorithm. Subsequently, Kim and Audet [11] successfully validated HDDE in vitro to identify the three serum-free CM formulations (Sol A-C) for cell expansion of CAR T-cells in vitro, which supported expansion comparable with the gold standard serum-containing T-cell media CM [11]. This was accomplished in 6 total generations experimentally testing less than 1×10⁻⁵% of the total search space. It is thus expected, and has been demonstrated as described below, that the improved HiDiNeu results described herein on three similar standard benchmark functions may translate to in vitro biological optimization, identifying more optimal CM formulations in a similar timeframe.

In some embodiments, the original HDDE [11] and HiDiNeu system described herein may operate over a discretized factor search space, as opposed to a more continuous search space as allowed by the original DE [12] algorithm. This set up was originally chosen based on previous work [10] and to simplify experimental procedures performed with human input [11]. Likewise, because of the high-dimensional optimization occurring, some embodiments of HiDiNeu systems may yield optimizations of factor-doses at levels that would be ignored by subject matter experts due to undiscovered mechanisms in smaller factor optimization datasets.

In some embodiments, operations of ANN and/or ML models associated with the HiDiNeu modelling pipeline may be conducted for various application scenarios. For example, it may be desirable to implement ANN and/or ML operations for deriving “factor rules” specific to a particular cell type and desired objective that can be used for rational design of cell culture media formulations. An example of such an application has been provided in [47] by a group working towards application of multi-task ANNs, built on very sparse polymer data, towards rational design of novel polymer materials. In some embodiments, HiDiNeu operations may be implemented for optimization of multiple biological objectives (or multi-tasks in ANNs) [14], which may be desirable for a fully automated QbD manufacturing pipeline. In some embodiments, HiDiNeu operation variants may provide for a collection of datasets [48] to build increasingly efficient models for developing methods for efficient rational design of cell culture media formulations. Minimizing or reducing reagent costs for formulations and maximizing a biological response of interest is a typical type of industrial problem that some embodiments of HiDiNeu can solve.

As described herein, in silico experiments were run on the Niagara supercomputer at the University of Toronto [49,50], in Python. Using final identified training-hyperparameters, replicate ANN models were trained on the data and the models were used to optimize predicted formulations in a naïve averaging ensemble fashion, to identify formulations that would maximize the predicted cell expansion. These were then compared to the experimentally validated top ranked formulations.

In addition to in silico experiments, certain in vitro experiments were run to validate some embodiments described herein. In some embodiments, in vitro methods included automated formulation preparation, T-cell culture methods, and cell count methods, as described below.

### Formulation Preparation

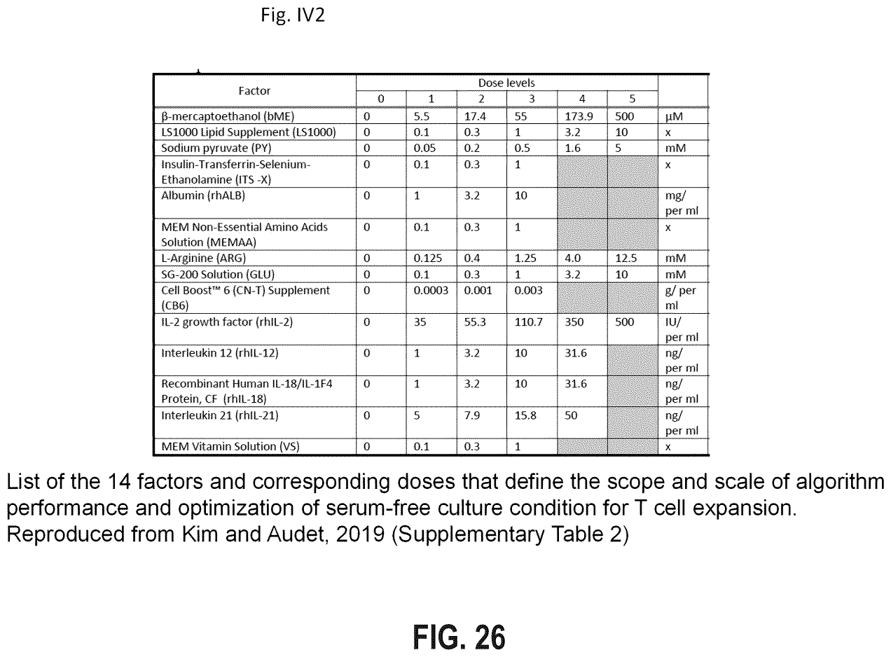

In some embodiments, cell culture medium formulations were prepared by combining basal media (BM) with 14 factors within a 96-deep well plate (DWP) using the Hamilton Vantage Automated Liquid Handler (Vantage). Each factor was assigned levels ranging from 0 to 5, with level 0 indicating the absence of the factor in the formulation. Some factors only had dose levels from 0 to 3 or from 0 to 4. Cell culture medium formulas are summarized in FIG. 26.

For each factor, serial dilutions were manually prepared to match the designated levels, with each dilution prepared at 20 times (20×) the final desired concentration. Subsequently, both BM and the different levels of each factor were loaded onto the deck of the Vantage. The media formulation script was executed on the Vantage to begin dispensing the required amount of BM into each well of the DWP. The next step in the script was to transfer 1/20^{th} of the final volume of the appropriate factor level into the corresponding DWP well. To maintain consistency, the appropriate level of each factor was added to the predefined wells of the DWP before proceeding to the next factor. The total duration to prepare 128 formulations at each generation (for a population size of 59, including 59 target formulations and 59 trial formulations) was approximately 4.5 hours. As such, the DWP containing the media formulations were stored in a 4° C. cooler within the Vantage. Additionally, factors were loaded into the Vantage in sets of three to ensure that none of the factors remained at room temperature for more than one hour.

Upon completing the media formulation, the contents of the wells were evenly divided into two DWPs. ImmunoCult Activator was added to one DWP and used for the initial seeding of T-cells. BM at equal volume as the ImmunoCult Activator was added to second DWP and stored at 4° C. for future use on Day 4.

Cell culture and cell counts: Frozen, freshly isolated CD3+ T-cells were retrieved from a Liquid Nitrogen tank, thawed in plating media, washed once and pelleted by centrifugation. The cells were then resuspended at a concentration of 5×10⁵ cells/mL in plating media, transferred to a single-well DWP, and loaded onto the Vantage. An automation script was executed on the Vantage to dispense 150 μL of the cell suspension into the wells of v-bottom 96-well plates. The plates were removed from the Vantage, centrifuged at 300 g for 5 minutes, and subsequently returned to the Vantage to remove the supernatant. The cells were then resuspended in 150 μL of media formulations from the DWP containing the ImmunoCult Activator. Subsequently, 100 μL of the resuspended cells were transferred to flat-bottom 96-well plates and were placed inside a humidified incubator and cultured at 37° C. for 4 days. At day 4 post-seeding, the 96-well flat-bottom plates were removed from the incubator and loaded onto the Vantage. The second DWP containing media formulations, previously prepared, was also loaded onto the Vantage, and 100 μL of the formulated media was transferred from the DWP to the respective wells in the flat-bottom 96-well plates. The plates were then returned to the incubator for an additional day of culture.

At day 5 post-seeding, the plates were transferred from the incubator to the Vantage. A 5 μM Calcein Orange stain was prepared in FACS buffer inside a single-well DWP and loaded onto the Vantage. An automation script was used on the Vantage to mix the cells in each well prior to transferring 50 μL of the cell suspension to a U-bottom 96-well plate. Subsequently, 50 μL of the Calcein stain was added to the cells and mixed. The plate containing the mixture of cells and Calcein stain was incubated at room temperature and protected from light for 20 minutes. Following incubation, it was analyzed on the Cytoflex, where the viability and viable cell density (VCD) of the cells in each well (media formulation) were calculated based on the total live cell events and the total volume analyzed by the flow cytometer. The VCD determined on Day 0 and 5 was then used to determine the fold change in T-cell expansion, allowing for the assessment of the effectiveness of each formulation.

In some embodiments, the implementation of the HiDiNeu system code may be adapted for an in vitro workflow. In some embodiments, an in vitro workflow may differ from an in silico workflow in the sense that an in vitro workflow must include interruptions between each generation (e.g. to allow time for a biological response to evolve and for researchers to assess such response with a biological assay). In some embodiments, interruptions between each data input (i.e. between each generation) may be at least one week long for a 5-day cell culture period and formulation preparation using robotics liquid-handling instrumentation, as well as initial and final cell counts by flow cytometry and additive shifts of baseline cell expansion from one generation to the next. In some embodiments, a series of ten control formulations (identified as IDs 119 to 128) were included and tested in each generation.

In addition, because in some embodiments, the formulations tested in the first generation were selected randomly (i.e. the doses for each factor were selected randomly among the selected number of possible doses), the same formulations that formed the first generation of the previous HDDE T-cell experiment were used for testing the HiDiNeu system to ensure a comparable initial state between the two experiments. The reagents were purchased from the same vendor where possible, although the same batches of reagents were not available. Additionally, the T-cell donors in the HDDE and HiDiNeu experiments were different.

For each generation, each target and trial formulation was tested (identified as ID 1 to ID 118) in triplicates, as well as the series of ten controls. In some embodiments, performance scores to be used as inputs in the HiDiNeu system were calculated for each trial and each target formulation in a given generation, by taking the base-10 logarithm of the ratio of the geometric mean of the cell number obtained with a given formulation to the geometric mean of cell number in the control ID 120 formulation, tested in the same generation.

In some embodiments, performance scores were calculated for each formulation in the generation and then used to fit a Random Forest model in which hyperparameters were tuned with Optuna (as shown in Table S2 below). After 200 trials on the Niagara Supercomputer at the University of Toronto, the best Random Forest model found was then numerically maximized with Optuna (by manipulating the 14 factor doses) to find a list of formulations whose compositions were predicted to score the highest. These predicted formulations were used to replace the lowest scoring formulations among the target and trial formulations, and initialize a new lineage of formulation from the model predictions.

Following the replacement of the low-scoring formulations, the DE framework 2310 was activated to generate the list of target and trial formulations to test in T cell culture in the next generation. This was repeated at each generation, by using a pool of the experimental scores from all the previous generations available to train the random forest model. As initially planned for the comparison, the experiment was terminated by the researchers after four generations. In some embodiments, the HiDiNeu system may include a termination module configured to determine whether to continue for another generation or to terminate.

### Training Artificial Neural Networks in HiDiNeu's Modelling Pipeline (in Silico)

In some embodiments, HiDiNeu may use an Artificial Neural Network (ANN) or a Random Forest. In these embodiments, the modelling pipeline in HiDiNeu may be split into two phases. The first phase may include the optimization of the neural architecture and training hyperparameters. This phase may be implemented to be fully automated, requiring no user input. However, it will be appreciated that those skilled in the art can nevertheless customize the operation of the first phase in Python for a specific use case.

In some embodiments, the optimization of both the neural architecture and training hyperparameters may be performed using the Optuna [38] framework in Python. The Optuna framework trials both architecture and training hyperparameters to collect data on the final training-validation error. In some embodiments, the trial count may be set to 100 by default in HiDiNeu, although it will be appreciated that other trial counts are contemplated. Optuna internally uses Tree Parzen Estimators on the collected data to predict a new round of configurations for hyperparameters predicted to minimize or improve the training-validation error.

In some embodiments, Optuna may be configured to sample configuration values from the following default ranges that are set in an HiDiNeu system. It will be appreciated that all configurations and default ranges can be modified by those skilled in the art in the Python script before each generation commences. In some embodiments, training and building of models occurs in PyTorch [51].

Table S1 below depicts example hyperparameter search ranges for an example HiDiNeu Modelling Pipeline. In some embodiments, HiDiNeu's Modelling Pipeline uses the Optuna framework (i.e. a Python library) that uses trials and sequential model-based optimization to optimize model hyperparameters (e.g. neural architecture and training-optimizer values). In some embodiments, the Optuna framework may sample values of hyperparameters from the following example ranges as specified in table S1 below. It will be appreciated that Table S1 relates specifically to embodiments which make use of ANNs for the modelling pipeline, and that in other embodiments it is contemplated that the modelling pipeline may make use of techniques other than ANNs, such as Random Forests and other machine learning techniques.

Neural Architecture Search

| | |
|---|---|
| Number of Hidden Layers (HL) | [3, 5] |
| Number of Activation Nodes / HL | [2 * D, 5 * D]; |
| | D = Number of factors |
| Activation Function | ReLU |

Training Optimizer Hyperparameters

| | |
|---|---|
| Optimizer | SGD |
| Learning Rate | [10⁻⁴, 1], log scale |
| Momentum | 0.9 |
| L2 Penalty Regularization | [10⁻³, 10⁻¹], log scale |
| Weight Initialization | kaiming_uniform |
| | (He initialization) |

Depending on the computing hardware being used, Optuna trials generally take about 30 minutes to complete an automated search through 100 trials before selecting the best set of hyperparameters. The best hyperparameters are selected to improve generalization of models against unseen data in the complete combinatorial factor-search space. As the number of generations increases (and correspondingly, the amount of complete experimental history) the complete computation time of the Optuna trials may increase. Once the replicate models are trained, using the replicate models for inference is static in time and linearly dependent upon the number of predictions requested.

One of the goals of the Modelling Pipeline is to act as a reproducible script in Python language given the same raw data. Thus, the script may commence to identify a set of hyperparameters that may then train ANNs that have low final training-validation errors. Although the script does not guarantee that the same set of hyperparameters will be returned, it is expected that given the same data, each identified set of hyperparameters will lead to final models having good generalization properties due to low validation error.

### Training Random Forest Models in HiDiNeu's Modelling Pipeline (In Vitro)

In some embodiments, the HiDiNeu Modelling Pipeline uses Machine Learning models. In some embodiments, the ML model may be a Random Forest model. In such embodiments, the modelling pipeline in HiDiNeu may be split into two phases. The first phase may include the optimization of a random forest architecture and training hyperparameters. As for the in silico study, this phase may be implemented to be fully automated, requiring no user input. However, it will be appreciated that persons skilled in the art can customize the operation of the first phase in Python for specific use cases. In some embodiments, the Optuna [38] framework was used with a trial count set to a default value of 200 for HiDiNeu. It will be appreciated that other trial count values and default values are contemplated, and that embodiments described herein are merely examples for the purposes of illustration. In some embodiments, training and building of random forest models may be carried out in Python scikit-learn.

Table S2 below depicts example HiDiNeu Modelling Pipeline hyperparameter search ranges for an example in vitro study. In some embodiments, the Optuna framework may sample values of hyperparameters from the following ranges as specified in the table below. It will be appreciated that other ranges for various values are contemplated.

Random Forest Architecture Search Hyperparameters

Number of Trees / Estimators
Maximum Depth
Minimum Samples Split (minimum number of
samples required to split an internal node)
Minimum Samples Leaf (minimum number of
samples required to be at a leaf node)
Maximum Features (method to determine
maximum number of samples considered to
split an internal node)
Bootstrap

In some embodiments, each Optuna trial will complete an automated search through 200 trials before selecting the best set of hyperparameters. It will be appreciated that the number of trials may be greater or lesser than 200, and that 200 trials is merely an example. After completing the automated search through the trials, the best hyperparameters are selected. In some embodiments, the best hyperparameters are those which improve generalization of models against unseen data in the complete combinatorial factor-search space. As the number of generations increases (and consequently, the amount of complete experimental history increases), the complete computation time of the Optuna trials is expected to increase. In some embodiments, Optuna may suggest optimal formulations that can be used to replace the lowest scoring of the population at block 2335.

One of the goals of the modelling pipeline is to act as a reproducible script in Python language given the same raw data. This means that the script will commence to identify a set of hyperparameters that may train random forest models that have very low final training-validation errors. The script may return different hyperparameters for different runs due to random sampling.

However, each identified set of hyperparameters may lead to final models showing good generalization properties due to low validation errors.

### L2 Norm (Euclidean Distance Metric)

Many embodiments and figures described herein use Error as a performance metric. In some embodiments, the weighted Euclidean Distance metric or L2-norm is used as an error score as defined in equation (1):

$${‖ E ‖}_{2} = \sqrt{{{w}_{a} ( {a}_{1} - {a}_{2} )}^{2} + {{w}_{b} ( {b}_{1} - {b}_{2} )}^{2} + {{w}_{c} ( {c}_{1} - {c}_{2} )}^{2} + {{w}_{d} ( {d}_{1} - {d}_{2} )}^{2}} \qquad ( Equation 1 )$$

where ∥E∥₂ corresponds to the L2-norm as error score, the predicted factor doses are represented by a₁ to d₁, the known maxima recipes/formulations are represented by a₂ to d₂, and the relative weights for each factor are respectively wₐ to w_{d}. For the standard benchmark functions (Equation (3-5)) described herein, the weights of each factor/dimension may be considered equal and set to 1.

### Traditional Quadratic Response Surface Model (RSM)

Many embodiments and figured described herein make reference to quadratic RSM models. In some embodiments, the traditional quadratic RSM model is shown in equation (2):

$$Y = K + {\sum }_{j = 1}^{D} {β}_{j} {x}_{j} + {\sum }_{i = 1}^{D} {\sum }_{j = 1}^{D} {β}_{ij} {x}_{i} {x}_{j} + {\sum }_{j = 1}^{D} {β}_{jj} {x}_{j}^{2} + ϵ \qquad ( Equation 2 )$$

where Y corresponds to the response (representing cell expansion fold) normalized to the positive control or known maxima and log transformed. K represents the intercept, D represents the number of factors/dimensions, βⱼ represents the main effect coefficient for factor j, βᵢⱼ represents the interaction effect coefficient between factors i and j, xⱼ and xᵢ represent the coded dose from range [−1, 1] for factor j and i respectively, and ϵ corresponds to the random error/noise.

### Standard Benchmark Functions for in Silico Experiments

As described above, the Rosenbrock (Equation (3)), Rastrigin (Equation (4)), and Ackley (Equation (5)) benchmarks were used as in silico simulated experimental environments in some embodiments. In some embodiments, each function's response was shifted, scaled and reversed to maximization so as to modify the equations to a more biologically relevant optimization space.

### Rosenbrock:

$$Y = {\sum }_{i = 1}^{D} [ 100 {( {x}_{i + 1} - {x}_{i}^{2} )}^{2} + {( {x}_{i} - 1 )}^{2} ] \qquad ( Equation 3 )$$

where Y corresponds to response used in Equation (6), D represents the number of factors/dimensions where D∈ [symbol] =[15, 25](D is an element of the set of natural numbers, comprising discrete whole numbers from the range 15 to 25 inclusive), xᵢ is the dose level of factor i where x∈ [symbol] =[0, 5].

### Rastrigin:

$$Y = 10 D + {\sum }_{i = 1}^{D} [ {x}_{i}^{2} - 10 cos ( 2 π {x}_{i} ) ] \qquad ( Equation 4 )$$

where Y corresponds to response used in Equation (6), D represents the number of factors/dimensions where D∈ [symbol] =[15, 25], xᵢ is the dose level of factor i where x∈ [symbol] =[0, 5].

### Ackley:

$$Y = - 20 exp ( - 0.2 \sqrt{\frac{{\sum }_{i = 1}^{D} {x}_{i}^{2}}{D}} ) - exp ( \frac{{\sum }_{i = 1}^{D} cos ( 2 π {x}_{i} )}{D} ) + 20 + exp ( 1 ) \qquad ( Equation 5 )$$

where Y corresponds to response used in Equation (6), D represents the number of factors/dimensions where D∈ [symbol] =[15, 25], xᵢ is the dose level of factor i where x∈ [symbol] =[0, 5].

### Normalized Response Score Equation

In some embodiments, each of the above equations (Equations 3-5) may have the score normalized with the known maxima defined by Equation (6):

$${Y}_{n o r m} = log ( \frac{Y}{K} ) + ϵ \qquad ( Equation 6 )$$

Where Yₙₒᵣₘ is the log transformed normalized score, Y is the original score as calculated using one of the Equations 3-5 above (normalized to a simulated initial seed count), K is the calculated score (normalized to a simulated initial seed count) using one of the Equation 3-5 above (the same equation as that chosen for Y) for the known maxima, and E corresponds to random noise/error added.

### Coefficient of Variation Calculations

In some embodiments, Coefficient of Variation (CV) is used as a measure of biological noise (in silico/vitro) present in experimental collected data. Biologically relevant noise may be calculated using previously collected data [52]. Depending on use case, such data has been obtained, for example, from the Pineault group at Canadian Blood Services, which works on culture media optimization for hematopoietic stem cells (HSCs). CD34+ cells were enriched and obtained from umbilical cord blood (CB) units from two donors and were pooled together [52]. Stem cell agonist cocktails (SCAC), to promote HSC proliferation were used in culture, as described in reference [52].

In one experiment, a four-factor central composite design (CCD), generated with JMP® Pro version 14.0 (SAS Institute Inc.), with 16 conditions, 12 center points, and 8 axial points (factors tested at 5 dose levels) was used. The design was replicated three times as independent orthogonal blocks. Following incubation in culture media, a portion of cultures was monitored for cell proliferation (expansion) on day 7 and 14 using an Attune® Cytometer (Thermo Fisher Scientific, Nepean, Canada) and cell sorting was carried out with a BD FACS Aria III (BD Biosciences). Specifically, the number of cells of specific phenotypes were counted for each condition (independently in each block).

Centre points in CCD design of the day 14 dataset were used in the calculation of the observed CV percentage. The cell counts of the phenotype comprising total nucleated cells (TNC, total nucleated cells representing most differentiated phenotype) were specifically used. CV percentages were calculated for each orthogonal block and then averaged. The averaged CV percentage for TNC cells was approximately 7.4%, which was rounded up to a final CV of 10%. This value was used as a baseline for low-level simulated noise. CV values representing medium and high levels of 30% and 70%, respectively, were also added to the experimental noise conditions tested. Simulated noise was added to the simulated response levels to generate variation/noise in final responses to formulations (or in silico Solution-Vectors).

### Simulated Response Noise

In some embodiments, the calculated levels of CV described above were used to compute the appropriate amount of random Gaussian (normal) noise/error (E) that is added in Equation 6 to simulated response values when testing the evolutionary algorithm variants. The CV percentage is used to compute the standard deviation of the Gaussian (normal) noise generating function. The levels of CV were set at 10% (low), 30% (medium), and 70% (high).

### Normalized Performance Score (NPS)

In some embodiments, the final top 5 identified in silico Solution-Vectors (iSV) were benchmarked against their true simulated response score on the corresponding benchmarks described herein (Equations 3-5). These scores were normalized to the corresponding benchmarks' known global maxima's true score (i.e., the top achievable score). This is referred to herein as the normalized performance score in this disclosure and the accompanying Figures.

$$N P S = \frac{Y}{K} \qquad ( Equation 7 )$$

where Y corresponds to the true response score of some identified top iSV on the corresponding benchmark Equation 3-5, K is the true response score of the known global maxima's true score on the same Equation 3-5.

Simulations and computations were performed on a Niagara supercomputer at the SciNet Digital Research Alliance.

FIG. 9 illustrates an example schematic of an activation node 902 (threshold logic unit) and fully connected artificial neural network (ANN) 912. For each activation node 902, each input x is scaled by its trained weight 904a, . . . , 904n and a linear combination is performed by the summing junction with a bias term 906 added before being passed on to an activation function 908 which outputs a non-linear response in the case of a hyperbolic-tangent or Gaussian function, or a straight pass-through of the output in the case of a linear function. In practice, ANNs are built up of many activation function nodes 902a, . . . 902n per hidden layer with multiple hidden layers. FIG. 9 depicts 8 inputs (labeled X1, X2 . . . X8) with output on the right (labelled Y8X+e(0.67)). As depicted, each input has a weighted arrow extended to one of nine activation function nodes 910 in the first hidden layer, the two hidden layers are likewise fully connected. Data flows in one direction from left to right with the inputs transformed non-linearly throughout.

FIG. 10 depicts error scores based on an L2 norm in the final identified top iSVs for each of DE, HDDE, HiDiNeu with modelling beginning at the 2^{nd} generation, and HiDiNeu with modelling beginning at the 8^{th} generation with a CV of 30%. The L2 norm error was defined as the square root of the sum of squared error measured along each factor-dose level. The HiDiNeu algorithm was run against 3 well known benchmark functions (Rosenbrock, Rastrigin, and Ackley) at multiple dimension (factor) levels (e.g. 15 factors, and 25 factors, as depicted in FIG. 10) for 6 separate runs. The top 5 iSVs (x-axis) were then scored against the true global maxima (as depicted, for example, in FIG. 14) along their dose levels as a measure of the accuracy (depicted as Error on the y-axis). As depicted, the HiDiNeu algorithm (HiDi_G2) decreased the final error of the top iSVs between 50% to 75% for the top 5 iSVs across all 3 benchmark functions. The improvement becomes more pronounced as the dimensionality of the problem increases, where it can be seen from FIG. 10 that final scores are similar for HiDiNeu between the 15 and 25 factor functions, whereas scores for the DE and HDDE algorithm increase with higher dimensionality. This suggests that the modelling pipeline of HiDiNeu can handles the exponential expansion of the problem space better than the original HDDE algorithm can. When HiDiNeu modelling is activated at generation 8, the error can be seen to be significantly higher. (n=6 replicate runs, mean±SD shown, simulated CV=30%).

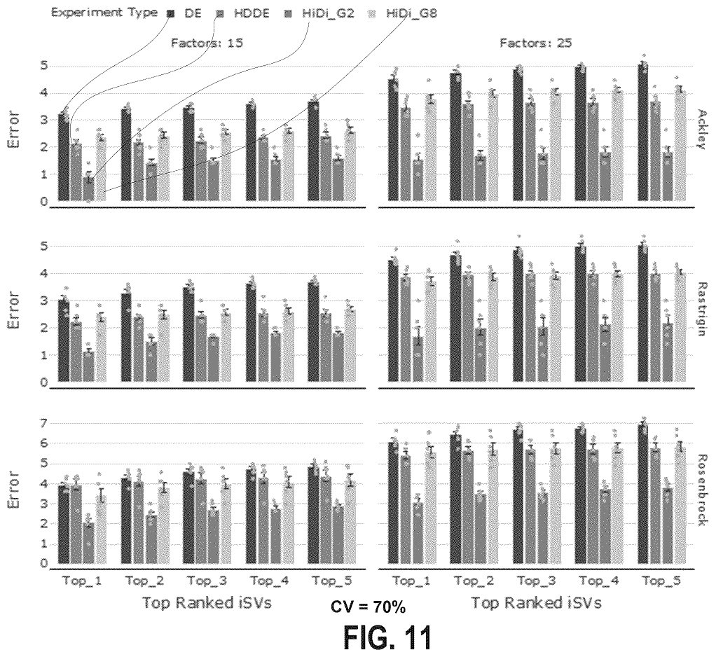

FIG. 11 depicts error scores based on an L2 norm in the final identified top iSVs with a CV of 70% for each of DE, HDDE, HiDiNeu with modelling beginning at the 2^{nd} generation, and HiDiNeu with modelling beginning at the 8^{th} generation. The L2 norm error was defined as the square root of the sum of squared error measured along each factor-dose level. The HiDiNeu algorithm was run against 3 well known benchmark functions (Rosenbrock, Rastrigin, and Ackley) at multiple dimension (factor) levels (15 and 25 factors) for 6 separate runs. The top 5 iSVs (x-axis) were then scored against the true global maxima (as depicted in FIG. 14) along their dose levels as a measure of the accuracy (depicted as Error on the y-axis). The HiDiNeu algorithm (HiDi_G2) decreased the final error of the top iSVs between 50% to 75% for the top 5 iSVs across all 3 benchmark functions. The improvement becomes more pronounced as the dimensionality of the problem increases, where it can be seen that final scores are similar for HiDiNeu between the 15 and 25 factor functions, while scores for the original HDDE algorithm increase at the higher dimensionality. This suggests that, even when facing large amounts of biological variance, the modelling pipeline handles the exponential expansion of the problem space better than the original HDDE algorithm. When HiDiNeu modelling is activated at generation 8, the error can be seen to be significantly higher (n=6 replicate runs, mean±SD shown, simulated CV=70%).

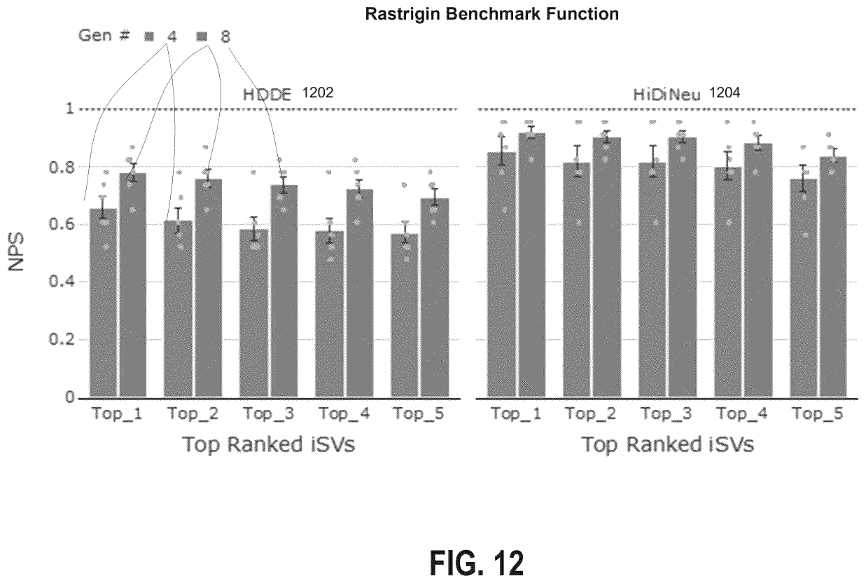

FIG. 12 depicts the True Scores of Top Identified iSVs for the Rastrigin benchmark function (Equation (4)). As depicted, the top identified iSVs discussed in FIG. 6 were used with the modified Rastrigin function to compute their true score as defined by the function, and these scores were normalized to the global maxima (identified the flat line having an NPS of 1). Clearly, iSVs that come closest to the dashed line perform the best. As shown, ANN modelling helps the HiDiNeu 1204 algorithm to identify better performing iSVs relative to the iSVs identified with HDDE 1202. In some runs, HiDiNeu successfully identifies the global maxima in the Top 1 Formulation position. The NPS scores of top iSVs from Generation 4 is also plotted in grey bars. It can be seen that HiDiNeu, in only four generations, identifies similarly scoring “top” formulations to those identified by HDDE in eight generations.

FIG. 13 depicts the True Scores of Top Identified iSVs for the Rosenbrock benchmark function (Equation (3)). As depicted, the top identified iSVs discussed in FIG. 6 were used with the modified Rosenbrock function to compute their true score as defined by the function, and these scores were normalized to the global maxima (identified as the flat line having a value of 1). iSVs that come closest to the dashed line perform the best. As shown, ANN modelling helps the HiDiNeu 1304 algorithm to identify better performing iSVs relative to the iSVs identified with HDDE 1302. In some runs, HiDiNeu successfully identifies the global maxima in the Top 1 Formulation position. NPS of top iSVs from G4 is also plotted in grey bars. It can be seen that HiDiNeu, in only four generations, identifies similarly scoring formulations to those identified by HDDE in eight generations.

FIG. 14 illustrates Standard benchmark functions Rosenbrock, Ackley, and Rastrigin modified towards biologically relevant optimization, and a Visual description of the Euclidean Error and normalized Performance Score. The Euclidean Error is a measurement of the similarity of identified top formulations 1402 and 1404 to the known best formulation 1406. The Euclidean Error is based on the Weighted L2 norm metric defined in FIG. 14 in which the weights are uniform. In the contour plot of the modified Ackley function the formulation identified by 1402 is considered closer to the known best formulation versus the formulation 1404 because the Euc₂ is smaller than the Euc₁ distance error. The goal is to ultimately reduce the Eucₓ errors as much as possible over the total generational runs. The Normalized Performance Score (NPS) is defined as the true score of identified Top Formulations 1402, 1404 normalized to the known best Formulation 1406. In this scenario, the goal is to increase the NPSₓ as close to 1 as possible, representing formulations that maximize a desired cell therapy product objective. NPS₁ is greater than NPS₂ as the true score of the formulation 1402 is much higher than the true score of formulation 1404.

FIG. 15 depicts the True Scores of Top Identified iSVs for the Ackley benchmark function (Equation (5)). In FIG. 15, the data is same as FIG. 7, with the addition of the standard DE 1502 as defined by Storn & Price [12], and the error scales have been re-drawn from 0 to 1. The top identified iSVs discussed in FIG. 6 were used with the modified Ackley function to compute their true score as defined by the actual function, and these scores were normalized to the global maxima (identified as a red dashed line). The goal is to identify the iSVs that score close to the dashed line with a value of 1. It can be seen that ANN modelling helps to identify better performing formulations versus the formulations identified with HDDE as indicated by the median of each top ranked formulation moving closer to the dashed line.

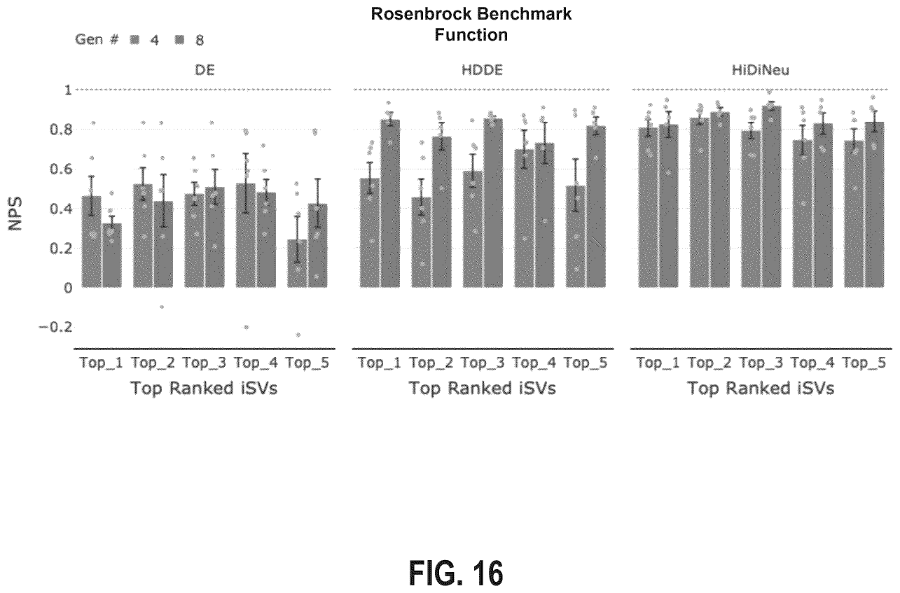

FIG. 16 illustrates the True Scores of Top Identified iSVs for the Rosenbrock benchmark function (Equation (3)). The data is same as FIG. 13, with the addition of the standard DE as defined by Storn & Price [12], and the error scales have been re-drawn from 0 to 1. The top identified iSVs discussed in FIG. 6 were used with the modified Rosenbrock function to compute their true score as defined by the actual function, and these scores were normalized to the global maxima (identified as a flat dashed line with a value of 1). The goal is to identify the iSVs that score close to this dashed line. It can be seen that ANN modelling helps to identify better performing formulations versus the formulations identified with HDDE as indicated by the median of each top ranked formulation moving closer to the red dashed line.

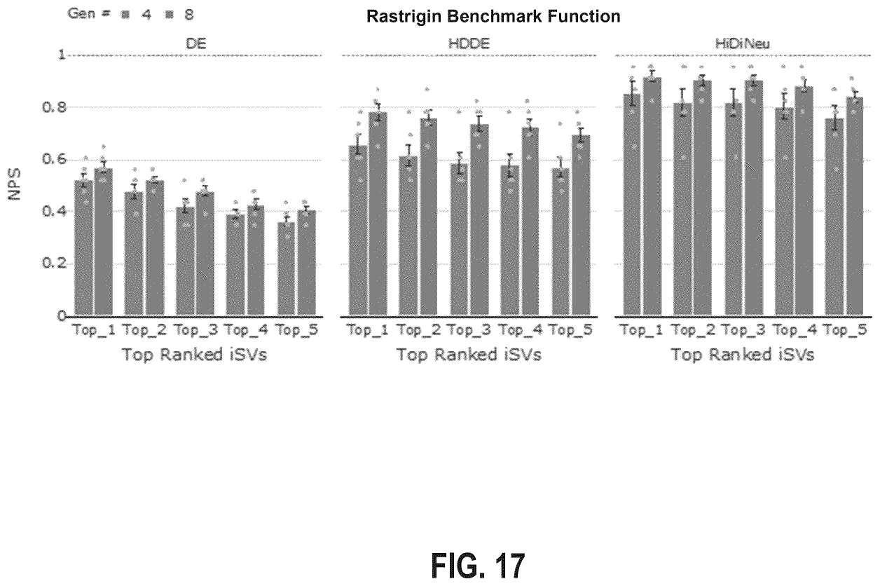

FIG. 17 illustrates True Scores of Top Identified iSVs for the Rastrigin benchmark function (Equation (4)). The data is same as FIG. 14, with the addition of the standard DE as defined by Storn & Price [12], and the error scales have been re-drawn from 0 to 1. The top identified iSVs discussed in FIG. 6 were used with the modified Rastrigin function to compute their true score as defined by the actual function, and these scores were normalized to the global maxima (identified as a dashed line with a value of 1). The goal is to identify the iSVs that score close to this dashed line. It can be seen that ANN modelling helps to identify better performing formulations versus the formulations identified with HDDE as indicated by the median of each top ranked formulation moving closer to the red dashed line.

Table S2 below depicts the average scores and improvement in error scores for HiDiNeu relative to differential evolution (DE) and HDDE at G4.

| # | | | | | HDDE/DE | HiDiNeu/DE | HiDiNeu/HDDE |
|---|---|---|---|---|---|---|---|
| Factors | Function | DE | HDDE | HiDiNeu | Improvement | Improvement | Improvement |
| 15 | Rosenbrock | 4.272 | 3.567 | 3.056 | 17% | 28% | 14%* |
| | Rastrigin | 3.255 | 2.775 | 1.702 | 15% | 48%* | 39% |
| | Ackley | 3.152 | 2.843 | 2.134 | 10% | 32% | 25% |
| 25 | Rosenbrock | 6.682 | 5.327 | 3.728 | 20% | 44% | 30% |
| | Rastrigin | 4.410 | 4.413 | 2.467 | −0.06% | 44% | 44% |
| | Ackley | 4.505 | 4.355 | 2.588 | 3% | 43% | 41% |

It can be seen that the mean error from FIG. 6 for the Top_1 formulation was tabulated, and percentage improvement in terms of decreasing the error score were calculated for HiDiNeu vs DE and HDDE. The data below was from the same runs tabulated in Table 1, however the results are from an earlier generation (G4 vs G8 in Table 1). The largest improvement can be seen for the Rastrigin function, where HiDiNeu error drops by 48% over DE, but only 39% over HDDE for a 15-factor space (with 10% CV). The lowest improvement occurs for Rosenbrock function with HiDiNeu improving by 28% over DE and 14% over HDDE for a 15-factor space. The lowest and highest percentage error decreases of HiDiNeu over either DE or HDDE are marked by asterisk.

These results indicate that if HiDiNeu is run for half the total number of generations in FIG. 6, it would still outcompete HDDE and identify formulations that had almost 50% less error score even at higher dimensionality of 25 factor space.

As described herein, there is evidence that HiDiNeu may create desirable formulations faster (e.g., in fewer generations and with correspondingly lower experimental costs) than HDDE in vitro.

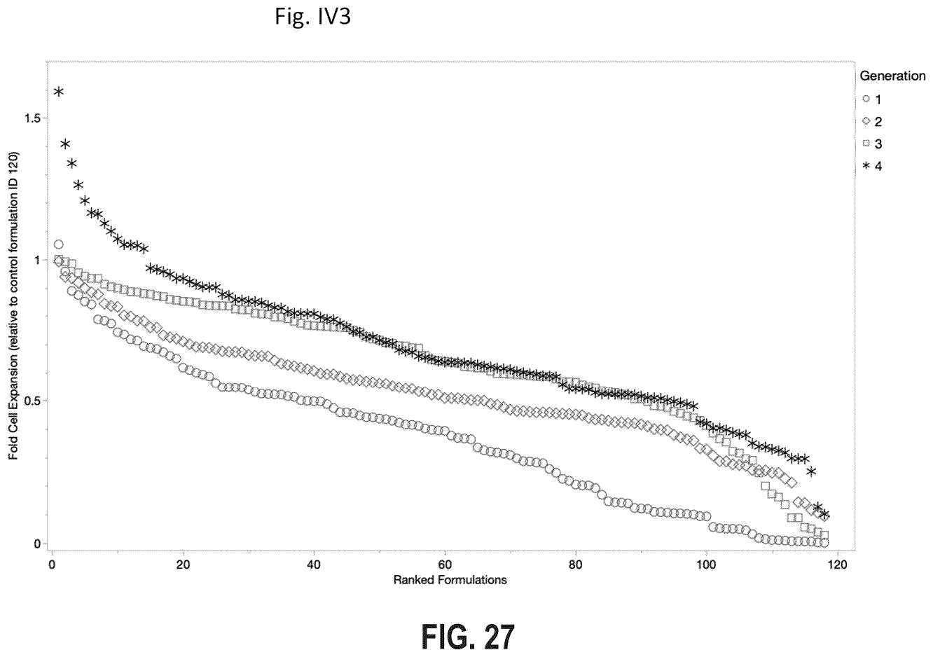

FIG. 27 depicts the results of in vitro experiments aimed at testing the performance of HiDiNeu relative to HDDE, particularly in terms of the amount of experimental work and time required to create desirable formulations for human T-cell cultures. Consequently, only four generations were tested with HiDiNeu (as opposed to six generations with HDDE in a previous study (Kim and Audet 2019)). Each generation included 118 formulations (population size 59, with target and trial formulations) tested in triplicated cultures in a randomized manner, and where each generation corresponded to an independent experiment (i.e. performed on different days). Formulations tested in generation 1 were identical to those randomly selected and tested in generation 1 in the previous HDDE experiment (Kim and Audet, 2019 [11]) while generations 2 to 4 included unique formulations created through HiDiNeu. Cell expansion in each culture was calculated after 5 days and compared with a control formulation (identified as ID 120) that corresponded to the best formulations created by HDDE over six generations in the previous study (Kim and Audet, 2019).

The ratio of the cell expansion obtained with each formulation to that of the control formulation tested in the same generation is depicted in FIG. 27. From generation 3, it can be seen that HiDiNeu created many formulations that had cell expansions similar to the control (i.e. a ratio=1) and, at generation 4, there were 14 formulations that had a level of cell expansion which was greater than that of the control (i.e. a ratio>1, which represents superior performance relative to the best formulation obtained through HDDE over 6 generations).

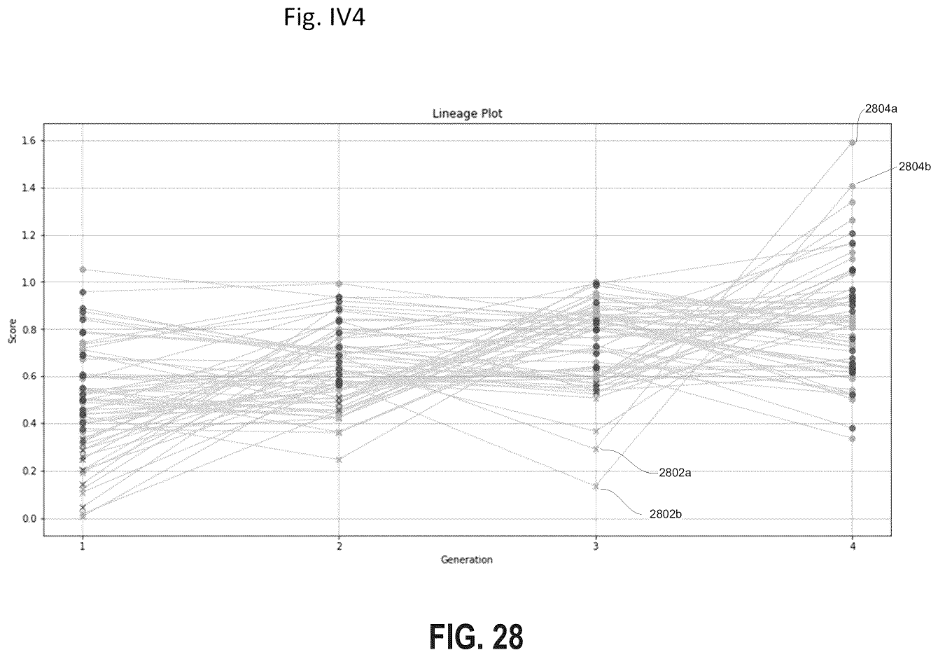

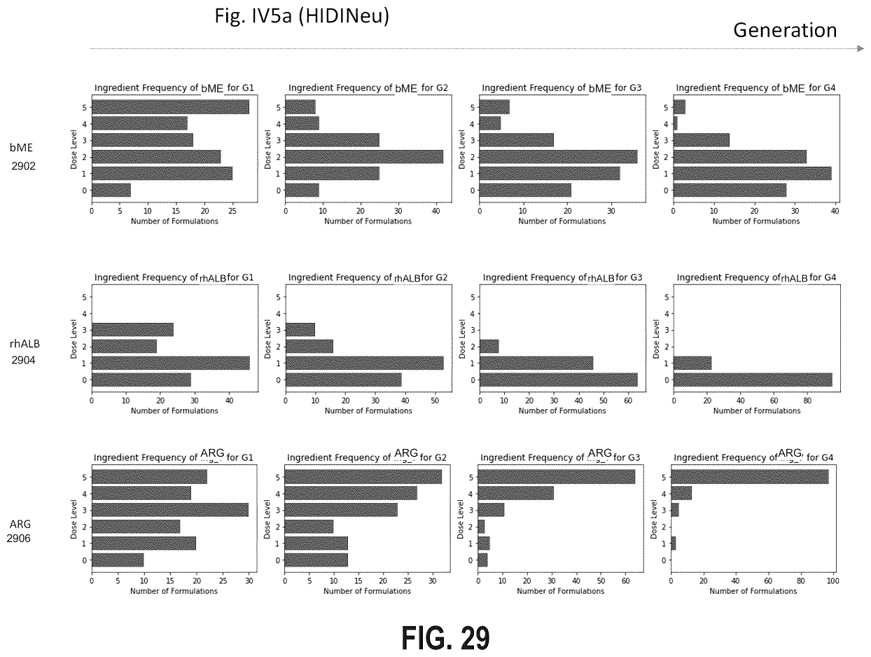

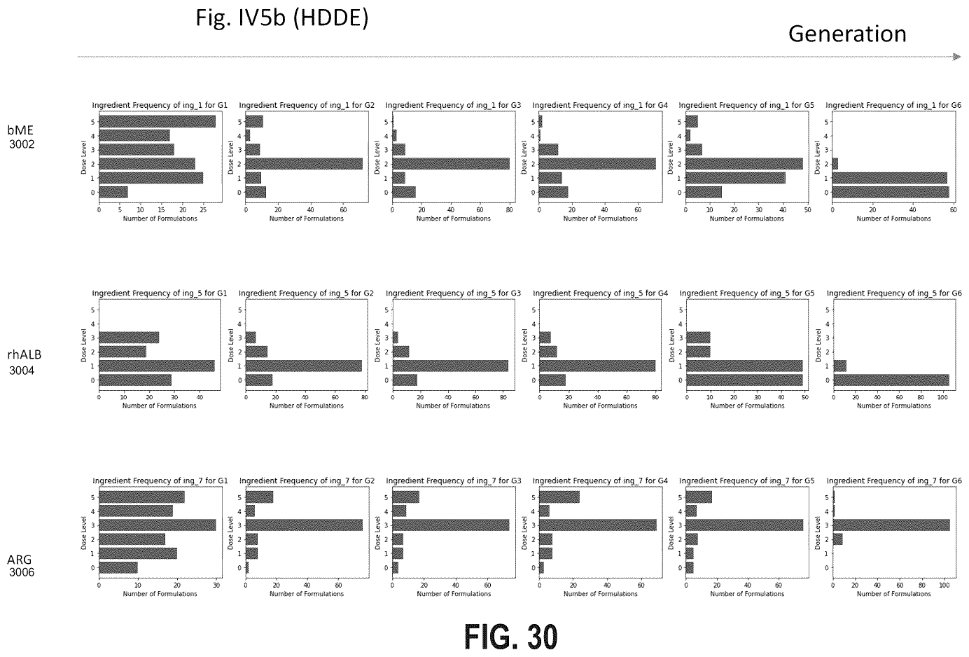

FIG. 28 is a lineage plot which illustrates how HiDiNeu may accelerate the discovery of desirable formulations relative to HDDE by interrupting lineages derived from lower-scoring formulations and replacing them with machine learning model-based predictions to initiate new lineages of formulations for subsequent generations. FIG. 28 shows that the highest scoring formulations in the 3^{rd} and 4^{th} generations were derived from machine learning model predictions that replaced low scoring formulations in the previous generation. In FIG. 28, dark circle markers indicate trial formulations, light circle markers are target formulations, and x markers indicate replaced formulations (i.e. interrupted and re-started lineages). It can be seen that by the 4^{th} generation several of the lower-scoring formulations which were replaced 2802a, 2802b ultimately yielded some of the highest-scoring formulations 2804a, 2804b in the next generation. FIG. 29 is a histogram depicting the change in distribution of representative active factor doses in formulations from generation 1 to generation 4 through the use of the HiDiNeu system. As depicted, HiDiNeu efficiently changed the distribution of active factor doses in the formulations within the population with high doses being favored for certain factors (e.g. ARG 2906), and lower doses favored for certain other factors (e.g. bME 2902 and rhALB 2904). Interestingly, the optimal doses for three of the 14 factors were reflected particularly clearly in the composition of the top performing formulations created by both HDDE (as shown in FIG. 30) and HiDiNeu (all had high levels of ARG and low levels of rhALB), and intermediate/low bME levels. This made it possible to observe, from the evolution of the distribution of factor doses across generations, that the optimization process was significantly slower for HDDE (as shown in FIG. 30) relative to HiDiNeu (as shown in FIG. 29). For example, by generation 4, only 20% of the formulations had the highest dose of ARG 3006 with HDDE, while 80% of the formulations for HiDiNeu were at the highest dose of ARG 2906 at that same point in lineage. Likewise, even by generation 6, there were fewer than 10% of the formulations at the highest dose of ARG 3006 with HDDE (as shown in FIG. 30). In addition, with HDDE, by the 4^{th} generation, 68% of the formulations had rhALB at a zero concentration, whereas 76% of formulations with HiDiNeu had a zero concentration. Both HDDE (FIG. 30) and HiDiNeu (FIG. 29) had very few formulations in the highest concentrations for bME by generation 4.

There is evidence that, compared with HDDE, the HiDiNeu strategy creates a larger number of formulations that support T cell growth at a level similar to positive controls.

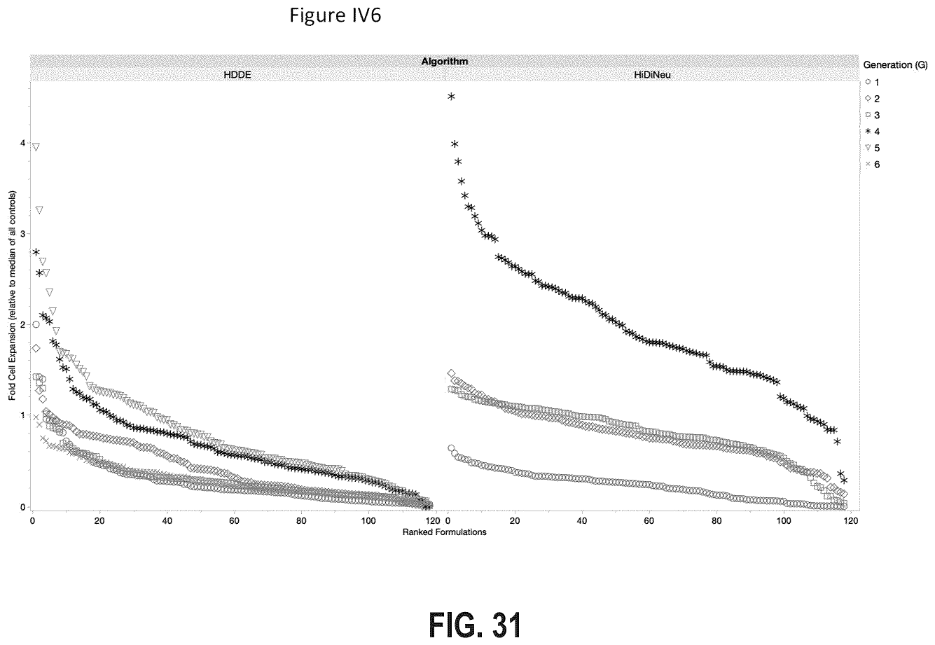

Additional insights into the inner workings of HiDiNeu relative to HDDE were obtained by re-analysing the cell expansion data for both studies. In the list of formulations of the published HDDE experimental data (Kim and Audet, 2019) it was possible to identify formulations with higher scores that were repeated in most generations, in addition to the serum-containing control (X-VIVO). The median cell expansion of these repeated formulations and controls were calculated for each generation and used to normalized the cell expansion values obtained for each formulation. The same calculations were performed for the HiDiNeu cell expansion data using the median of the series of 10 controls that were repeated in each generation. This data is presented in FIG. 31, which provides a comparison of HDDE data to HiDiNeu data and where the first generation is composed of the same set of random formulations.

Given that the formulations in generation 1 (that are identical) scored in the same range for HDDE and HiDiNeu, that the lowest scores are in a similar range, and that the highest scores are also in a similar range, this suggests that, although not exact, the normalization procedure is a fair yet conservative comparison between the HDDE and HiDiNeu. FIG. 30 further indicates that, from generation 1 and 2 and from generation 3 and 4, there are more formulations that are improved, compared with the previous generation, with HiDiNeu than with HDDE. Also, after 4 generations, the top formulations created with HiDiNeu have scores that are higher than those created with HDDE.

There is evidence that a retrospective approach where a machine learning model is trained with data from several past cell culture experiments might not be as effective as using the dynamic HiDiNeu framework to design experiments to generate data points to train machine learning models.

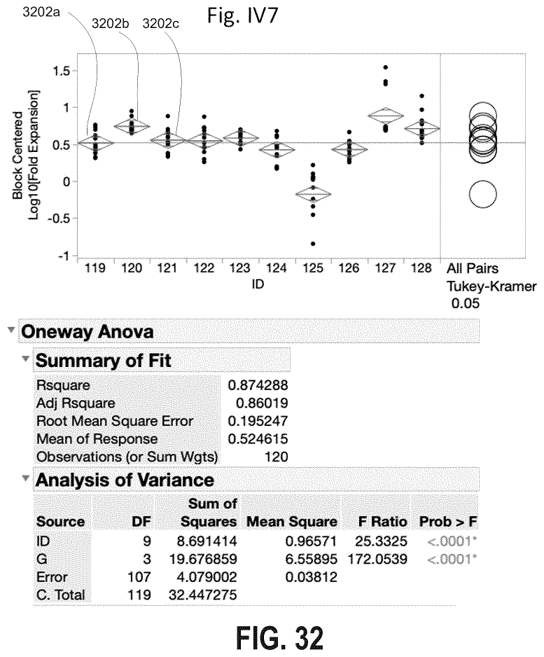

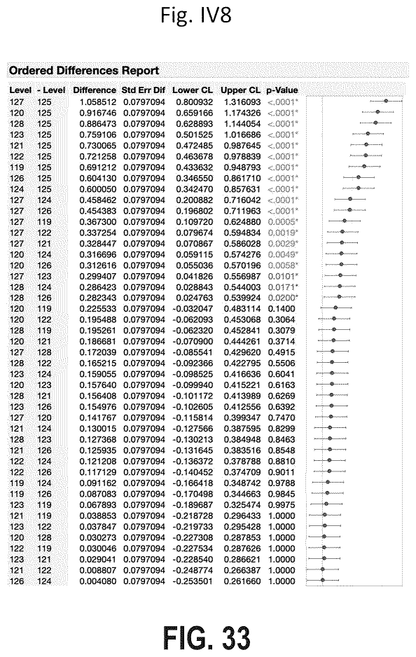

T cell culture experiments (G1 to G4) included a series of controls to further evaluate HiDiNeu's performance relative using machine leaning alone with historical cell culture data, as often performed in industrial and academic laboratories. A series of ten control formulations (ID 119 to 128) were included and tested in each generation. This series of controls included two formulations that contained serum (ID 127 and ID 128) and the top five formulations from Kim and Audet (2019) created by HDDE (ID 119 to 124), with ID 120 being the best of the five. Formulation IDs 124, 125, 126 were obtained from predictions from a random forest machine learning model trained using the entire data set from Kim and Audet 2019 with JMP Pro 17. A parametric one-way ANOVA for a randomized blocked design (with a log transformed response to stabilize the variance) is depicted in FIG. 32 and was used for testing the difference in mean cell expansion for ten groups (technical triplicates repeated in four independent experiments, i.e. 4 levels corresponding to 4 generations for the blocking factor in the ANOVA). As depicted, each diamond 302a, 3202b, 3202c, . . . 3202n represents the top and bottom of a 95% confidence interval for the mean of each grouping, with the middle line across the diamond representing the mean. The statistical test (α=5%) rejected Hₒ: the means are equal therefore, and there was evidence to claim that there are significant differences between the mean cell expansion for some of the ten controls. A post-hoc multiple comparison test Tukey Kramer HSD indicated that the formulations created retrospectively by training a machine learning model with six generations of T cell culture data were not as desirable as the best formulation discovered by HDDE (formulation ID 120) and the 14 best formulations discovered by HiDiNeu, which in this experiment, had greater cell expansion compared with ID 120 (as noted in FIG. 27, with 14 formulations scored above 1). The mean cell expansions for formulation IDs 124, 125, and 126 were significantly different (lower) than control formulation ID 120, as well as the positive serum controls (ID 127 and ID 128), while the mean cell expansion of ID 120 was not statistically significantly different than the serum controls (as depicted in FIG. 33, which depicts the results of an ordered differences report showing, for various pairs of formulations and controls tested side by side, statistically significant (e.g. the top of the list) and non-significant (e.g. the bottom of the list) differences in mean performance scores).

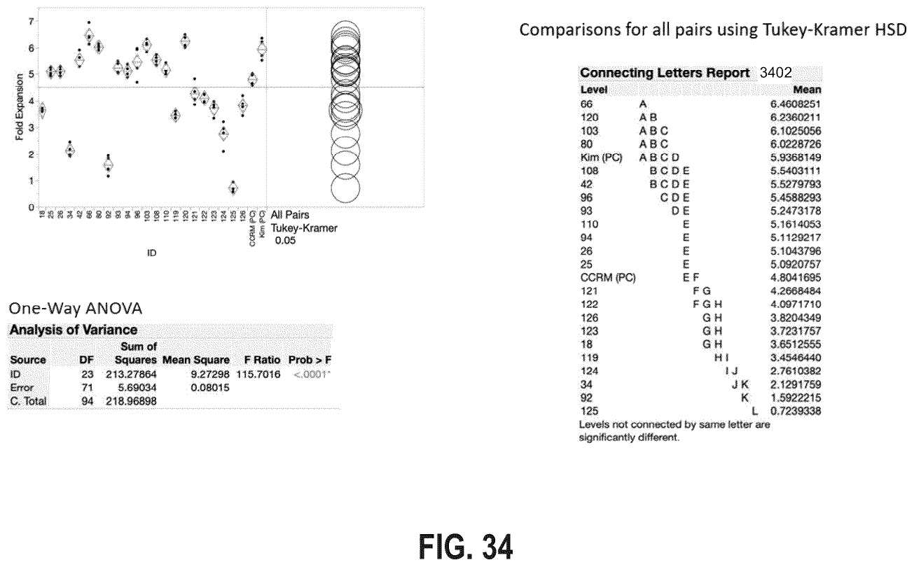

A further experiment was conducted in which formulations were tested in four replicates distributed on a single 96-well cell culture plate to ensure uniform conditions. The results are depicted in FIG. 34.

FIG. 34 depicts the top 14 formulations from the 4^{th} generation iteration of HiDiNeu (e.g. formulation IDs 18, 25, 26, . . . 110) from left to right, which were re-tested side-by-side with formulation IDs 119-123, which are the top 5 formulations from the HDDE study (Kim and Audet, 2019), with the best formulation being ID 120. Continuing along, formulation IDs 124-126 are three formulations predicted by a post-hoc random forest model fit of the data from the HDDE study. The lower scores for formulation IDs 124-126 provide further evidence that a retrospective model fitting approach is not as effective as the HiDiNeu approach. The final two groups on the right in FIG. 34 are the two serum-containing medium controls (Kim (PC) and CCRM (PC), which use a positive control to benchmark the formulations as the serum-containing media are expected to support maximum or near-maximum cell proliferation by providing a complex mixture of growth factors.

As can be seen from FIG. 34, statistical analyses with a one-way ANOVA followed by multiple comparisons with Tukey-Kramer HSD method reveal that formulation IDs 66, 80 and 103 predicted by HiDiNeu have the highest and same level of cell expansion as formulation ID 120 (i.e. the best formulation from the HDDE study). The level of cell expansion is as high and not statistically different than the level obtained with the X-VIVO serum control (Kim PC or ID 127). Notably, the CCRM serum control was significantly lower in cell expansion, which suggests that a ceiling of cell expansion was reached with X-VIVO (Kim PC or ID 128) and some of the best formulations.

Among the subset of formulations in FIG. 34 that had the highest and statistically similar mean cell expansions, there were formulations that varied dramatically in terms of the cost of the reagents that compose these formulations. The HDDE top formulation (ID 120) has an associated cost at the present time of approximately $2.00 per mL, whereas one of HiDiNeu's top formulations only costs $0.30 per mL (ID 80), which having a level of cell expansion which is just as high (as shown in the Connecting Letters Report 3402 of FIG. 34). Formulation ID 66 also notably costs $1.00 per mL, representing another alternative with significantly lower associated costs.

In some embodiments, a training-validation error score during the training of trial or final Artificial Neural Network (ANN) models may be provided by:

$${‖ E ‖}_{2} = \sqrt{{( {z}_{1} - {z}_{2} )}^{2}}$$

The inputs of the ANN models may be the factor-elements, and the output may be the predicted in vitro/silico biological score. This means that z₁ may be the predicted in vitro/silico biological score, and z₂ may be the true measured in vitro/silico biological score. The ANN training's goal may be to reduce this error down as much as it can so that the final trained model has high accuracy to either in silico or in vitro real-world objective scores.

The training-validation error score during the training of trial or final Artificial Neural Network (ANN) models is defined by the formula above. The inputs of the ANN models would be the factor-elements, and the output would be the predicted in vitro/silico biological score. This means that z₁ is the predicted in vitro/silico biological score, and z₂ is the true measured in vitro/silico biological score. Therefore, the ANN training's goal is to reduce this error down as much as it can so that the final trained model has high accuracy to either in silico or in vitro real-world objective scores.

In some embodiments, systems and methods for machine learning architecture may be configured to conduct operations based on the following portions of pseudocode. For example, operations may include identifying neural and/or machine learning architectures and training hyperparameters:

PSEUDOCODE 1: IDENTIFY BEST NEURAL ARCHITECTURE
AND TRAINING HYPERPARAMETERS

| | // HiDiNeu Process Steps Block 5.1 |
|---|---|
| | Input: complete experimental data |
| | Output: best architecture & training hyperparameters to minimize generalization error |
| 1 | Create Optuna Study |
| 2 | Initialize n_trials = 100 |
| 3 | For trial in n_trials: |
| 4 | \| BUILD TRIAL MODEL // (see pseudocode 2) |
| 5 | \| Train TRIAL MODEL on complete experimental data |
| 6 | \| Log cross-validation error in Optuna Study |
| 7 | End |
| 8 | Identify trial in Optuna Study with lowest cross-validation error as best_trial |
| 9 | Return optimal architecture and training hyperparameters of best_trial as best_params |

In some embodiments, systems and methods described herein may be configured to perform operations based on the following portions of pseudocode. For example, in some embodiments, operations may include one or more trial models:

PSEUDOCODE 2: BUILD TRIAL MODEL

| | Input: # of factors in biological formulation |
|---|---|
| | Output: machine learning model with chosen hyperparameters + random initial weights |
| 1 | Initialize # of factors in biological formulation as NUM_FEATS |
| 2 | Select activation function as ReLU or TanH |
| 3 | Select dropout_percentage from range [0.1, 0.5] |
| 4 | Select num_hidden_layers from range [2, 5] |
| 5 | Select n_activation_functions from range [2 * NUM_FEATS, 5 * NUM_FEATS] |
| 6 | Select learning_rate from logarithmic range [1e−4, 1] |
| 7 | Select L2 penalty_regularization from logarithmic range [1e−3, 0.1] |
| 8 | Return machine learning model with selected hyperparameters above |

In some embodiments, systems and methods described herein may be configured to conduct operations based on the following portions of pseudocode. For example, in some embodiments, operations may include optimizing and/or maximizing formulations:

PSEUDOCODE 3: OPTIMIZE (MAXIMIZE) FORMULATIONS

| | Input: best_params // settings for architecture and training hyperparameters | | |
|---|---|---|---|
| | Input: complete experimental history | | |
| 1 | Initialize n_models = [5, 10] | | |
| 2 | For model in n_models: // HiDiNeu Process Steps Block 5.2 | | |
| 3 | \| | Train model using best_params and store in ensemble_pool | |
| 4 | End | | |
| 5 | For i until 5: // HiDiNeu Process Steps Block 5.3 | | |
| 6 | \| | For model in ensemble_pool: | |
| 7 | \| | \| | Use model to identify formulation that maximizes biological objective score |
| 8 | \| | \| | Store identified formulation into local_pool |

| | | |
|---|---|---|
| 9 | \| | End |

| | |
|---|---|
| 10 | End |
| 11 | Average local_pool along each factor dimension // see explanation below |
| 12 | Store averaged formulation recipe into replacement_pool |
| 13 | Send replacement_pool to global_memory_pool of differential evolution engine |
| | // HiDiNeu Process Steps Block 5.4 |

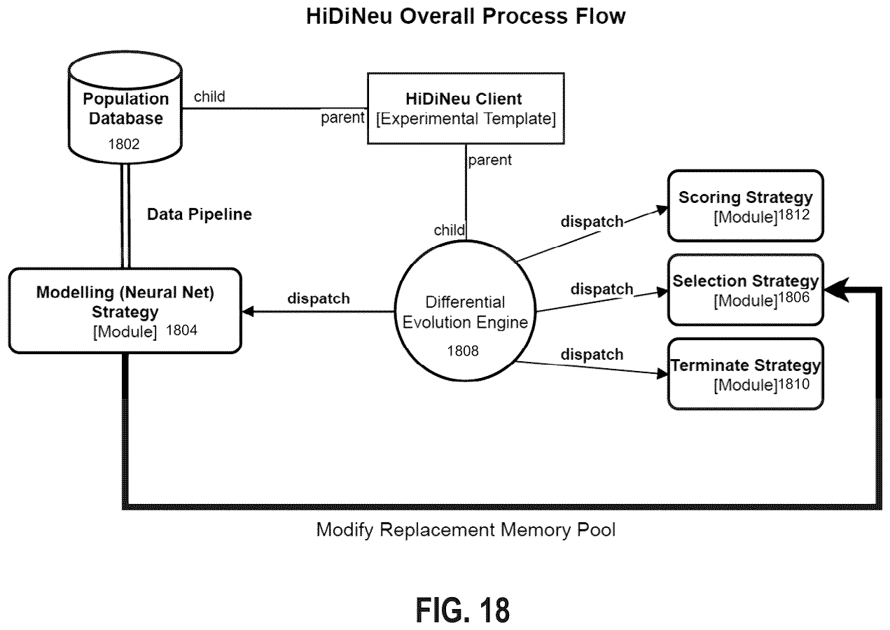

FIG. 18 is a process flow diagram for implementing a HiDiNeu system, in accordance with embodiments of the present disclosure. As depicted, a population database 1802 stores historical data on some or all previously analyzed or scored formulations. The modelling strategy module 1804 may receive the historical data and create a plurality of machine learning models which may predict better-performing formulations. These predictions may then be transmitted to a selection strategy 1806 module for the HDDE engine 1808, which replaces a subset of the lower-performing formulations with the predicted formulations for the next generation or iteration of the process. Scoring is performed by scoring module 1812. In some embodiments, a termination strategy module 1810 may be configured to end the process when a given generation of formulations has achieved a sufficiently high score to exceed a threshold level of performance.

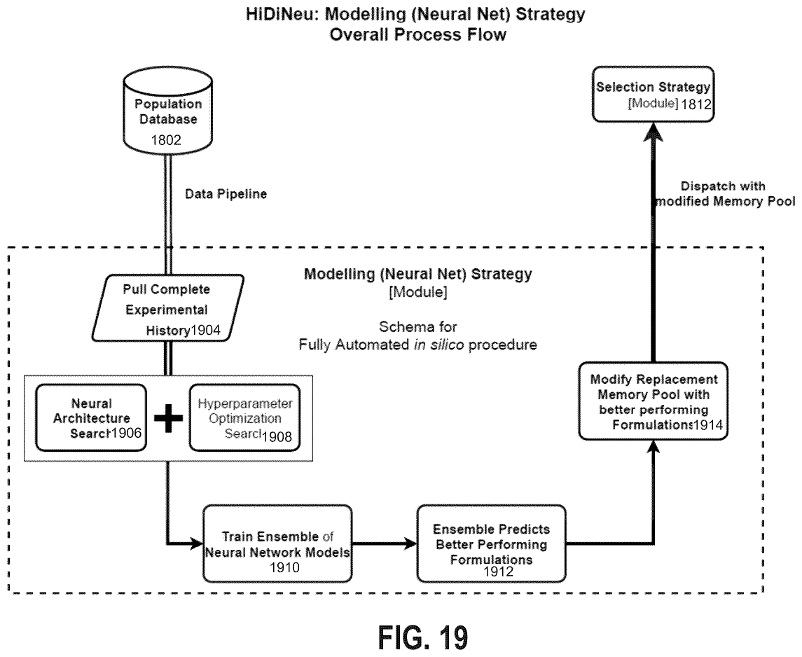

FIG. 19 is a process flow diagram depicting operation of an example modelling module for training a neural network. As depicted, complete historical data for previous experiments 1904 may be pulled from population database 1802 and used to perform both a Neural Architecture Search 1906 and hyperparameter optimization 1908. Once hyperparameters have been optimized for the selected neural network architecture(s), an ensemble of ANNs is trained at block 1910 to predict formulations having minimized error. At block 1912, the ensemble of ANNs generates one or more predicted formulations predicted to achieve higher scores than the lowest performing formulations from the previous generation or iteration. At block 1914, the memory module modifies the memory pool to replace the lowest scoring formulations with the formulations predicted by the ensemble of ANNs, which results are then transmitted to the selection strategy module 1812.

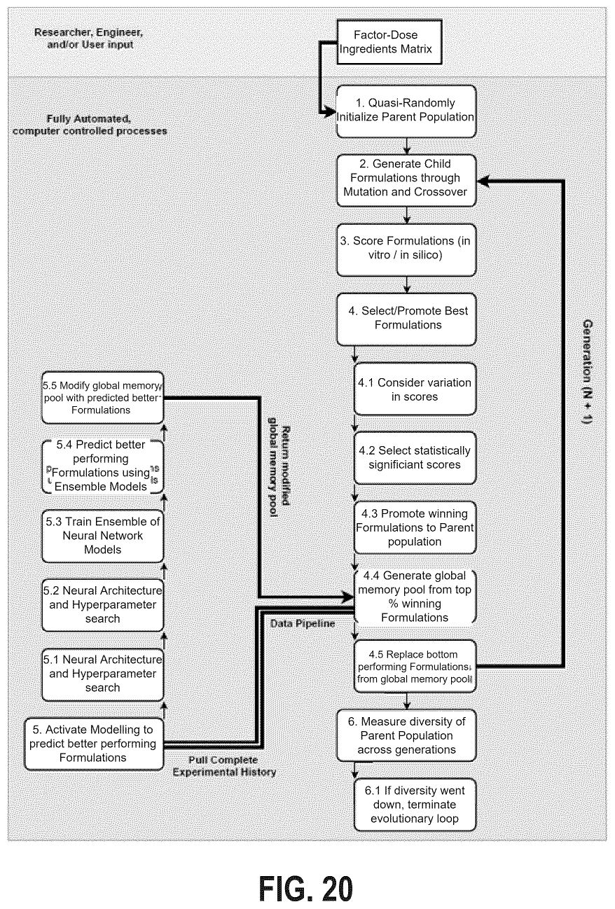

FIG. 20 is a flowchart depicting an example method of generating a population and replacing the lowest performing members of the population with predicted better formulations. The method may be conducted by a processor of a computing platform. Processor-executable instructions may include operations such as data retrievals, data manipulations, data analysis, data storage, or other operations, and may include computer-executable operations. As depicted, a factor-dose ingredients matrix may be used to quasi-randomly generate an initial parent population at block 1. At block 2, child formulations are generated through mutations and crossovers, which are then scored at block 3. In some embodiments, scoring may be performed in silico. In some embodiments, scoring may be performed in vitro. At block 4, once scoring is complete, the highest scoring or best performing formulations may be selected and promoted to a Pareto set for use in a subsequent iteration. Using the aforementioned Neural Architecture Search and hyperparameter optimization, an ensemble of ANNs may predict formulations having improved performance and modify the memory pool such that predicted formulations are added to the Pareto set and used in the next child formulation population. In some embodiments, the process may be terminated at block 6 and 6.1 if the diversity of the parent population has decreased across generations.

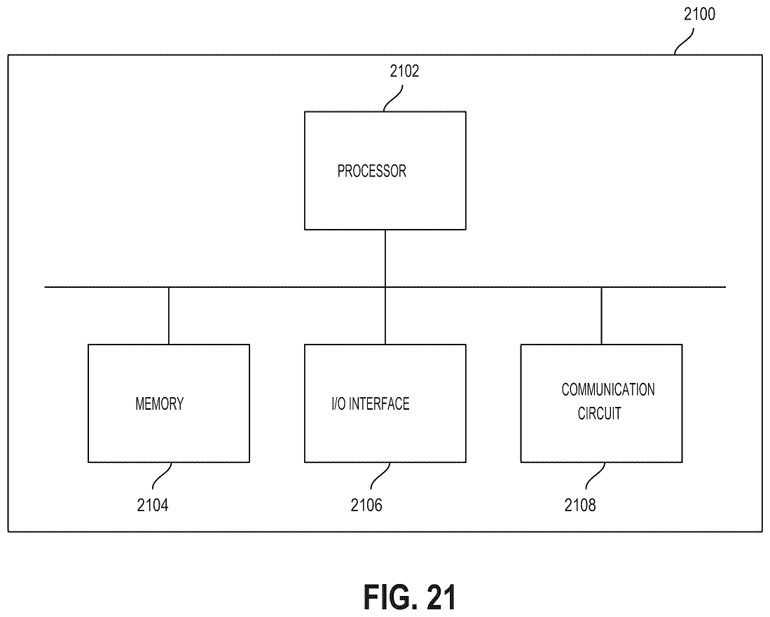

As noted above, numerous embodiments herein rely on the use of computing devices in order to process and implement machine learning models which generate predicted formulations. FIG. 21 is a block diagram depicting components of an example computing device 2100, in accordance with some embodiments. As an example, the computing device 2100 may be a supercomputer.

As depicted, the computing device 2100 may include at least one processor 2102, memory 2104, at least one I/O interface 2106, and at least one communication circuit 2108. The processor 2102 may be a microprocessor or microcontroller, a digital signal processing processor, an integrated circuit, a field programmable gate array, a reconfigurable processor, a programmable read-only memory, among other examples.

The memory 2104 may include a computer memory that may be located either internally or externally such as, for example, random-access memory, read-only memory, compact disc read-only memory, electro-optical memory, magneto-optical memory, erasable programmable read-only memory, and electrically-erasable programmable read-only memory, Ferroelectric RAM, or the like.

The I/O interface 2106 may enable the computing device 2100 to interconnect with one or more input devices, such as a keyboard, mouse, camera, touch screen and a microphone, or with one or more output devices such as a display screen and a speaker.

The communication circuit 2108 may be configured to receive and transmit data sets, for example, to a target data storage or data structures. In some embodiments, the communication circuit 2108 is a network interface configured to allow for communication between different computing devices 2100. In some embodiments, communication between computing devices 2100 may occur via a network, such as the internet.

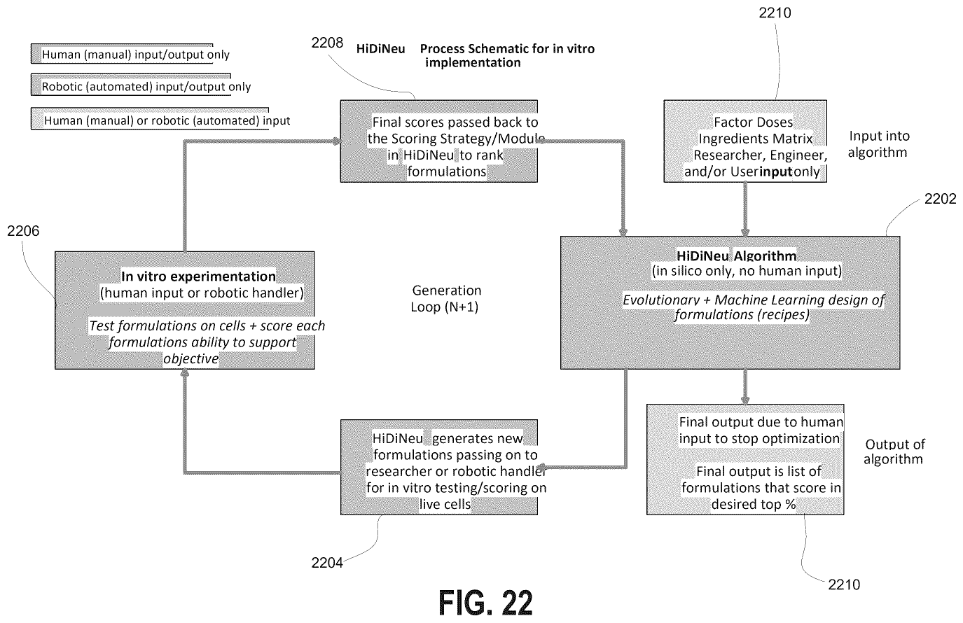

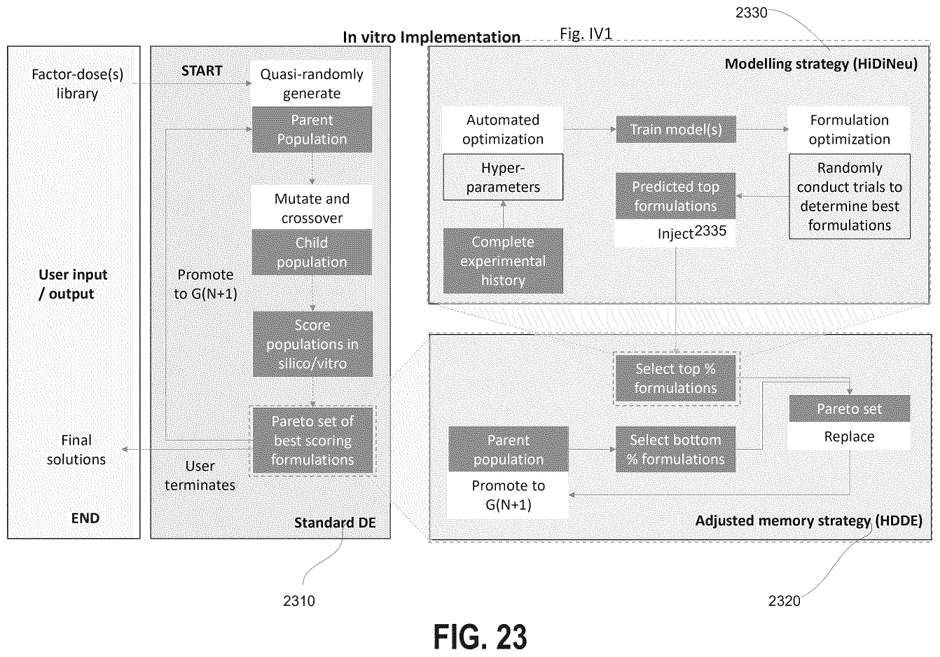

FIG. 22 is a flowchart depicting an example process for an in vitro implementation of a High-Dimensionality Differential Evolution (HDDE) process which incorporates a modelling pipeline that uses machine learning techniques, in accordance with some embodiments. As depicted, although many portions of the process can be fully automated without human or user input, it should be noted that blocks 2206 (testing various formulations on cells and scoring each formulation in terms of its ability to support a particular objective) and 2208 (entering final scores from in vitro experimentation for transmission to the scoring module) may still require human input, although it is possible that block 2206 may be performed using a robotic handler. That being said, it can be seen that blocks 2204 (generating new formulations and passing such formulations on to a human or robotic handler for in vitro testing) and 2202 (the use of machine learning models in combination with differential evolutionary algorithms to design formulations) may be performed completely automated manner without human input. Finally, it can be seen that blocks 2202 (providing the initial input values to the HiDiNeu system) and 2210 (stopping the optimization process and providing a final output in the form of a list of formulations that have the desired characteristics) may require human input, but may also be performed without human input.

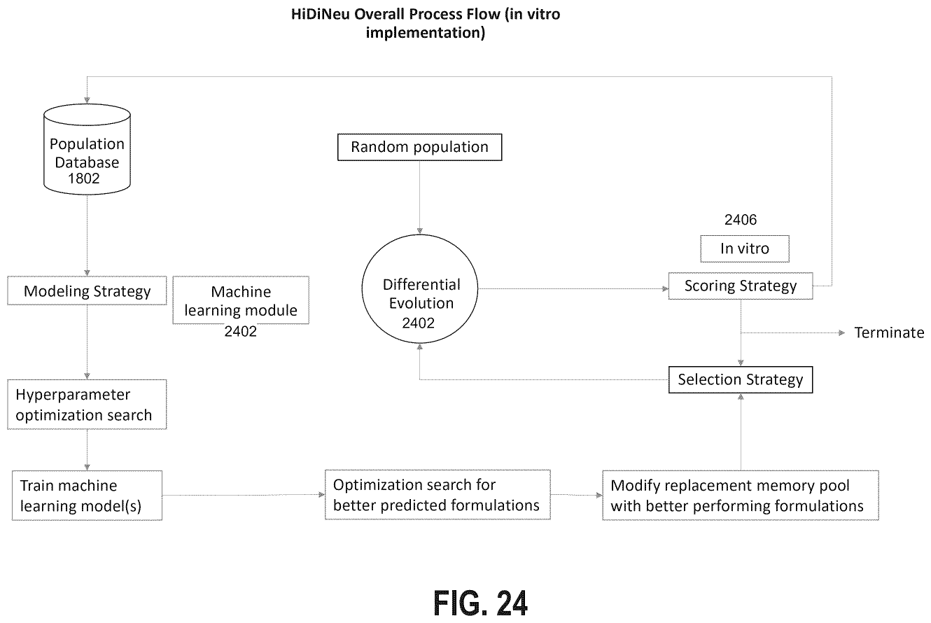

FIG. 24 is a schematic diagram depicting an overall process flow for an in vitro HiDiNeu system, in accordance with some embodiments. As depicted, although differential evolution engine 2402 may be implemented as an automated computing device, the scoring of resulting formulations is performed in vitro 2406. Moreover, while formulations are being tested, the computing process will essentially pause until new scoring data is received for the resulting performance of the cells in the formulations. Once new scoring data is received, it may be added to population database 1802, which may then be used by the machine learning module 2404 to carry out an on-going model architecture and hyperparameter optimization search, and then train ML models to identify formulations predicted to have better performance. In an HiDiNeu system, these predicted formulations will be injected into the memory pool and will replace formulations which are performing the worst from the previous generation.

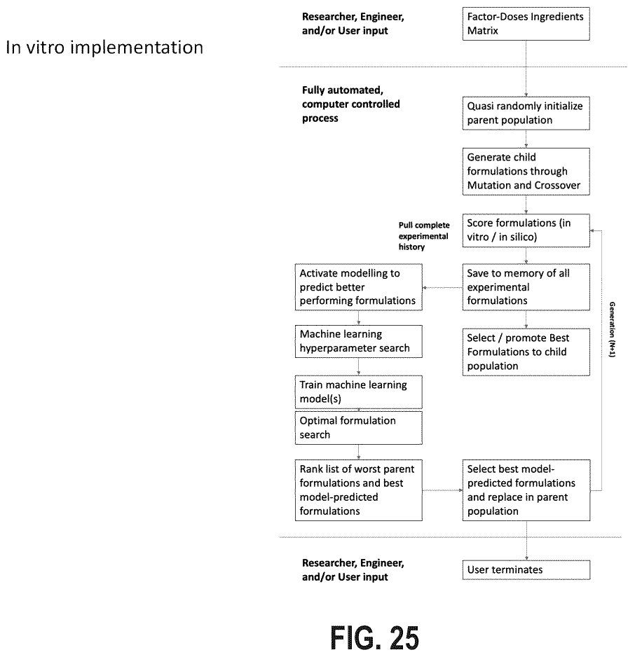

FIG. 25 is a process diagram for an example in vitro implementation of a HiDiNeu system, in accordance with some embodiments. FIG. 25 is similar to the process depicted in FIG. 19, with some modifications. For example, the process of FIG. 25 terminates when the user provides a termination input, whereas the process of FIG. 19 optionally terminates the process if diversity has decreased across generations.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope.

Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks.

The embodiments described herein provide useful physical machines and particularly configured computer hardware arrangements.

As can be understood, the examples described above and illustrated are intended to be exemplary only.

### REFERENCES

1 Information, K. Cell Therapy and Gene Therapy Markets. (2020).
2 Lipsitz, Y. Y., Timmins, N. E. & Zandstra, P. W. Quality cell therapy manufacturing by design. Nat Biotechnol 34, 393-400, doi:10.1038/nbt.3525 (2016).
3 Jayaraman, P., Lim, R., Ng, J. & Vemuri, M. C. Acceleration of Translational Mesenchymal Stromal Cell Therapy Through Consistent Quality GMP Manufacturing. Frontiers in Cell and Developmental Biology 9, 636 (2021).
4 King, R. D. et al. The Automation of Science. Science 324, 85-89, doi:10.1126/science.1165620 (2009).
5 Wu, T. & Zhou, Y. An Intelligent Automation Platform for Rapid Bioprocess Design. J Lab Autom 19, 381-393, doi:10.1177/2211068213499756 (2014).
6 Dai, X., Mei, Y., Nie, J. & Bai, Z. Scaling up the Manufacturing Process of Adoptive T Cell Immunotherapy. Biotechnol J 14, e1800239, doi:10.1002/biot.201800239 (2019).
7 Holland, I. & Davies, J. A. Automation in the Life Science Research Laboratory. Front. Bioeng. Biotechnol. 8, 1326 (2020).
8 Vasilevich, A. & de Boer, J. Robot-scientists will lead tomorrow's biomaterials discovery. Current Opinion in Biomedical Engineering 6, 74-80, doi:https://doi.org/10.1016/j.cobme.2018.03.005 (2018).
9 Tsutsui, H. An optimized small molecule inhibitor cocktail supports long-term maintenance of human embryonic stem cells. Nat. Commun. 2, doi:10.1038/ncomms1165 (2011).
10 Calzolari, D. et al. Search algorithms as a framework for the optimization of drug combinations. PLoS Comput Biol 4, e1000249, doi:10.1371/journal.pcbi.1000249 (2008).
11 Kim, M. M. & Audet, J. On-demand serum-free media formulations for human hematopoietic cell expansion using a high dimensional search algorithm. Commun Biol 2, 48, doi:10.1038/s42003-019-0296-7 (2019).
12 Storn, R. & Price, K. Differential evolution—A simple and efficient heuristic for global optimization over continuous spaces. J. Glob. Optim. 11, 341-359, doi:10.1023/a:1008202821328 (1997).
13 Elmeligy, A., Mehrani, P. & Thibault, J. Artificial Neural Networks as Metamodels for the Multiobjective Optimization of Biobutanol Production. Applied Sciences 8, doi:10.3390/app8060961 (2018).
14 Coello Coello, C. A., González Brambila, S., Figueroa Gamboa, J., Castillo Tapia, M. G. & Hernández Gómez, R. Evolutionary multiobjective optimization: open research areas and some challenges lying ahead. Complex & Intelligent Systems 6, 221-236, doi:10.1007/s40747-019-0113-4 (2020).
15 Balkin, S. D. & Lin, D. K. J. A neural network approach to response surface methodology. Communications in Statistics—Theory and Methods 29, 2215-2227, doi:10.1080/03610920008832604 (2000).
16 Stokes, J. M. et al. A Deep Learning Approach to Antibiotic Discovery. Cell 180, 688-702.e613, doi:https://doi.org/10.1016/j.cell.2020.01.021 (2020).
17 Yu, H.-C., Huang, S.-M., Lin, W.-M., Kuo, C.-H. & Shieh, C.-J. Comparison of Artificial Neural Networks and Response Surface Methodology towards an Efficient Ultrasound-Assisted Extraction of Chlorogenic Acid from Lonicera japonica. Molecules 24, 2304, doi:10.3390/molecules24122304 (2019).
18 Hiscock, T. W. Adapting machine-learning algorithms to design gene circuits. BMC Bioinformatics 20, 214, doi:10.1186/s12859-019-2788-3 (2019).
19 Kavvas, E. S. et al. Machine learning and structural analysis of Mycobacterium tuberculosis pan-genome identifies genetic signatures of antibiotic resistance. Nature Communications 9, 4306, doi:10.1038/s41467-018-06634-y (2018).
20 Huang, S.-M., Kuo, C.-H., Chen, C.-A., Liu, Y.-C. & Shieh, C.-J. RSM and ANN modeling-based optimization approach for the development of ultrasound-assisted liposome encapsulation of piceid. Ultrasonics Sonochemistry 36, 112-122, doi:https://doi.org/10.1016/j.ultsonch.2016.11.016 (2017).
21 Kuo, C.-H., Liu, T.-A., Chen, J.-H., Chang, C.-M. J. & Shieh, C.-J. Response surface methodology and artificial neural network optimized synthesis of enzymatic 2-phenylethyl acetate in a solvent-free system. Biocatalysis and Agricultural Biotechnology 3, I-6, doi:https://doi.org/10.1016/j.bcab.2013.12.004 (2014).
22 Desai, K. M., Survase, S. A., Saudagar, P. S., Lele, S. S. & Singhal, R. S. Comparison of artificial neural network (ANN) and response surface methodology (RSM) in fermentation media optimization: Case study of fermentative production of scleroglucan. Biochemical Engineering Journal 41, 266-273, doi:https://doi.org/10.1016/j.bej.2008.05.009 (2008).
23 Pugh, C. C. in Real Mathematical Analysis 1-55 (Springer, 2015).
24 Jong, K. A. D. An analysis of the behavior of a class of genetic adaptive systems, University of Michigan, (1975).
25 Fister, I. et al. Artificial neural network regression as a local search heuristic for ensemble strategies in differential evolution. Nonlinear Dynamics 84, 895-914, doi:10.1007/s11071-015-2537-8 (2016).
26 Rosenbrock, H. H. An Automatic Method for Finding the Greatest or Least Value of a Function. The Computer Journal 3, 175-184, doi:10.1093/comjnl/3.3.175 (1960).
27 Ackley, D. A connectionist machine for genetic hillclimbing. Vol. 28 (Springer Science & Business Media, 2012).
28 Rastrigin, L. (Nauka, Moscow, 1974).
29 Géron, A. Hands-On Machine Learning with Scikit-Learn, Keras & TensorFlow: Concepts, Tools, and Techniques to Build Intelligent Systems. (O'Reilly Media, Inc., 2019).
30 Smith, L. N. A disciplined approach to neural network hyper-parameters: Part 1—learning rate, batch size, momentum, and weight decay. ArXiv abs/1803.09820 (2018).
31 Stathakis, D. How many hidden layers and nodes?International Journal of Remote Sensing 30, 2133-2147, doi:10.1080/01431160802549278 (2009).
32 Smith, C. et al. Ex vivo expansion of human T cells for adoptive immunotherapy using the novel Xeno-free CTS Immune Cell Serum Replacement. Clin Transl Immunology 4, e31, doi:10.1038/cti.2014.31 (2015).
33 Bergstra, J., Komer, B., Eliasmith, C., Yamins, D. & Cox, D. D. Hyperopt: a Python library for model selection and hyperparameter optimization. Computational Science & Discovery 8, 014008, doi:10.1088/1749-4699/8/1/014008 (2015).
34 Liu, C. et al. in Proceedings of the European conference on computer vision (ECCV). 19-34.
35 Elsken, T., Metzen, J. H. & Hutter, F. Neural architecture search: A survey. The Journal of Machine Learning Research 20, 1997-2017 (2019).
36 Wistuba, M., Rawat, A. & Pedapati, T. A survey on neural architecture search. arXiv preprint arXiv:1905.01392 (2019).
37 Pham, H., Guan, M., Zoph, B., Le, Q. & Dean, J. in International Conference on Machine Learning. 4095-4104 (PMLR).
38 Akiba, T., Sano, S., Yanase, T., Ohta, T. & Koyama, M. in Proceedings of the 25th ACM SIGKDD international conference on knowledge discovery & data mining. 2623-2631.
39 Lévesque, J.-C., Gagné, C. & Sabourin, R. Bayesian hyperparameter optimization for ensemble learning. arXiv preprint arXiv:1605.06394 (2016).
40 Box, G. E., Hunter, W. H. & Hunter, S. Statistics for experimenters. Vol. 664 (John Wiley and sons New York, 1978).
41 Fort, S., Hu, H. & Lakshminarayanan, B. Deep ensembles: A loss landscape perspective. arXiv preprint arXiv:1912.02757 (2019).
42 Lakshminarayanan, B., Pritzel, A. & Blundell, C. Simple and scalable predictive uncertainty estimation using deep ensembles. arXiv preprint arXiv:1612.01474 (2016).
43 Wright, S. & Nocedal, J. Numerical optimization. Springer Science 35, 7 (1999).
44 Wales, D. J. & Doye, J. P. Global optimization by basin-hopping and the lowest energy structures of Lennard-Jones clusters containing up to 110 atoms. The Journal of Physical Chemistry A 101, 5111-5116 (1997).
45 Aijaz, A. et al. Biomanufacturing for clinically advanced cell therapies. Nat Biomed Eng 2, 362-376, doi:10.1038/s41551-018-0246-6 (2018).
46 Lagziel, S., Gottlieb, E. & Shlomi, T. Mind your media. Nature Metabolism 2, 1369-1372, doi:10.1038/s42255-020-00299-y (2020).
47 Kuenneth, C. et al. Polymer informatics with multi-task learning. Patterns 2, doi:10.1016/j.patter.2021.100238 (2021).
48 Federico, A. & Monti, S. Contextualized Protein-Protein Interactions. Patterns 2, doi:10.1016/j.patter.2020.100153 (2021).
49 Ponce, M. et al. in Proceedings of the Practice and Experience in Advanced Research Computing on Rise of the Machines (learning) Article 34 (Association for Computing Machinery, Chicago, IL, USA, 2019).
50 Loken, C. et al. SciNet: Lessons Learned from Building a Power-efficient Top-20 System and Data Centre. Journal of Physics: Conference Series 256, 012026, doi:10.1088/1742-6596/256/1/012026 (2010).
51 Paszke, A. et al. Pytorch: An imperative style, high-performance deep learning library. Advances in neural information processing systems 32, 8026-8037 (2019).
52 Manesia, J. K. et al. Development of stem cell agonist cocktails AA2P synergizes with stem cell agonists to promote expansion of stem cells. (Submitted manuscript).

1. A machine learning modeling pipeline system for manufacturing a formulation using a differential evolution strategy, the system comprising:
a processor;
a memory coupled to the processor and storing processor-executable instructions that, when executed, configure the processor to:
receive a respective score for each of a set of formulations, said formulations based on a plurality of factors and doses for said factors, said set of formulations including a top scoring subset of said formulations having scores which exceed a threshold, and said formulations further including a bottom scoring subset of said formulations having the lowest scores;
store said respective scores in a memory module;
generate, by a machine learning modeling pipeline, a plurality of predicted formulations predicted to have scores that exceed said scores of said bottom scoring subset, said predicted formulations having different factors and/or doses for said factors; and
determine a subsequent set of formulations for production, said subsequent set of formulations comprising said top scoring subset and replacing said bottom scoring subset with said plurality of predicted formulations.

2. The system of claim 1, wherein generating said plurality of predicted formulations predicted to have scores that exceed said scores of said bottom scoring subset comprises:
retrieving, from said memory module, a historical experimental data set representing prior observed formulations;
generating a plurality of formulation models based on said historical data set, said one or more formulation models being defined by a plurality of hyperparameters, wherein said hyperparameters are selected for converging on a minimized training-validation error score;
training the one or more formulation models based on the historical data set to identify one or more optimized formulation models having the minimized training-validation error score; and
generating, by an ensemble of the one or more formulation models, said plurality of predicted formulations.

3. The system of claim 2, wherein the one or more formulation models are random forest machine learning models and/or Artificial Neural Networks (ANNs).

4. The system of claim 3, wherein the hyperparameters include at least a number of trees, a maximum depth, a minimum number of samples required to split an internal node, a minimum number of samples required to be at a leaf node, and a strategy type for determining a maximum number of samples considered to split said internal node.

5. (canceled)

6. The system of claim 1, wherein said machine learning modeling pipeline is a closed loop operating without user input.

7. The system of claim 1, wherein the product formulation is a cell culture medium.

8. The system of claim 7, wherein the cell culture medium is animal-free and fully chemically defined.

9. The system of claim 7, wherein the cell culture medium is adapted for a particular cell type.

10. The system of claim 9, wherein said cell type is T cells, cardiac cells, animal cells, plant cells, algae cells, yeast cells, immune cells and/or mammalian cells.

11. The system of claim 1, wherein said factors comprise at least 15 factors.

12. (canceled)

13. The system of claim 1, further comprising:
generating said subsequent set of formulations through mutation and/or crossover of said subsequent set of formulations;
determining a respective score for each of said subsequent set of formulations, said subsequent set of formulations including a top scoring subset of formulations having scores which exceed a threshold, and said subsequent set of formulations including a bottom scoring subset of formulations having the lowest scores;
storing said respective scores in said memory module;
generating, by said machine learning modeling pipeline, a second plurality of predicted formulations predicted to have scores that exceed said bottom scoring subset of said subsequent set of formulations; and
determining another subsequent set of formulations, said another subsequent set of formulations comprising said top scoring subset of said subsequent set of formulations and replacing said bottom scoring subset of said subsequent set of formulations with said second plurality of predicted formulations.

14. The system of claim 2, wherein said historical data set comprises an accumulation of data from prior observed sets and subsequent sets of formulations.

15. A method of manufacturing a formulation using a differential evolution strategy and a machine learning modeling pipeline, the method comprising:
receiving, by one or more processors, a respective score for each of a set of formulations, said formulations based on a plurality of factors and doses for said factors, said set of formulations including a top scoring subset of said formulations having scores which exceed a threshold, and said formulations including a bottom scoring subset of said formulations having the lowest scores;
storing, by said one or more processors, said respective scores in a memory module;
generating, by said machine learning modeling pipeline, a plurality of predicted formulations predicted to have scores that exceed said scores of said bottom scoring subset, said predicted formulations having different factors and/or doses for said factors; and
determining, by said one or more processors, a subsequent set of formulations for production, said subsequent set of formulations comprising said top scoring subset and replacing said bottom scoring subset with said plurality of predicted formulations.

16. The method of claim 15, wherein generating said plurality of predicted formulations predicted to have scores that exceed said scores of said bottom scoring subset comprises:
retrieving, from said memory module, a historical experimental data set representing prior observed formulations;
generating a plurality of formulation models based on said historical data set, said one or more formulation models being defined by a plurality of hyperparameters, wherein said hyperparameters are selected for converging on a minimized training-validation error score;
training the one or more formulation models based on the historical data set to identify one or more optimized formulation models having the minimized training-validation error score; and
generating, by an ensemble of said one or more formulation models, said plurality of predicted formulations.

17. The method of claim 16, wherein the one or more formulation models are random forest machine learning models and/or Artificial Neural Networks (ANNs).

18. The method of claim 17, wherein the hyperparameters include at least a number of trees, a maximum depth, a minimum number of samples required to split an internal node, a minimum number of samples required to be at a leaf node, and a strategy type for determining a maximum number of samples considered to split said internal node.

19. (canceled)

20. (canceled)

21. The method of claim 15, wherein the product formulation is a cell culture medium adapted for a particular cell type selected from a group consisting of: T cells, cardiac cells, animal cells, plant cells, algae cells, yeast cells, immune cells and/or mammalian cells.

22. (canceled)

23. (canceled)

24. (canceled)

25. (canceled)

26. The method of claim 15, wherein said factors comprise at least 25 factors.

27. The method of claim 15, further comprising:
generating said subsequent set of formulations through mutation and/or crossover of said subsequent set of formulations;
determining a respective score for each of said subsequent set of formulations, said subsequent set of formulations including a top scoring subset of formulations having scores which exceed a threshold, and said subsequent set of formulations including a bottom scoring subset of formulations having the lowest score;
storing said respective scores in said memory module;
generating, by said machine learning modeling pipeline, a second plurality of predicted formulations predicted to have scores that exceed said bottom scoring subset of said subsequent set of formulations; and
determining another subsequent set of formulations, said another subsequent set of formulations comprising said top scoring subset of said subsequent set of formulations and replacing said bottom scoring subset of said subsequent set of formulations with said second plurality of predicted formulations.

28. (canceled)

29. A non-transitory computer-readable storage medium having stored thereon computer-executable instructions that, when executed by one or more processors, cause the one or more processors to perform a method of manufacturing a formulation using a differential evolution strategy and a machine learning modeling pipeline, the method comprising:
receiving, by said one or more processors, a respective score for each of a set of formulations, said formulations based on a plurality of factors and doses for said factors, said set of formulations including a top scoring subset of said formulations having scores which exceed a threshold, and said formulations including a bottom scoring subset of said formulations having the lowest scores;
storing, by said one or more processors, said respective scores in a memory module;
generating, by said machine learning modeling pipeline, a plurality of predicted formulations predicted to have scores that exceed said scores of said bottom scoring subset, said predicted formulations having different factors and/or doses for said factors; and
determining, by said one or more processors, a subsequent set of formulations for production, said subsequent set of formulations comprising said top scoring subset and replacing said bottom scoring subset with said plurality of predicted formulations.
